(19) United States
(12) Patent Application Publication
(10) Pub. No.: US 2025/0139081 A1
(43) Pub. Date: May 1, 2025

(54) RECONSTRUCTING A PRECURSORY INHERITANCE DATASET

(71) Applicant: Ancestry.com DNA, LLC, Lehi, UT (US)

(72) Inventors: Clinton C. Mason, Lehi, UT (US); Yong Wang, Foster City, CA (US)

(21) Appl. No.: 18/927,700

(22) Filed: Oct. 25, 2024

Related U.S. Application Data
(60) Provisional application No. 63/593,867, filed on Oct. 27, 2023.
(60) Provisional application No. 63/626,506, filed on Jan. 29, 2024.

(51) Int. Cl. G06F 16/23

(52) U.S. Cl. CPC G06F 16/2365

(57) ABSTRACT

Disclosed is a method for reconstructing a precursory genome using cognates' genotype data. The method includes receiving a plurality of data instances from a plurality of cognates, each data instance corresponding to one of the cognates. The method includes phasing each data instance to generate a pair of phased data segments for each cognate of the plurality of cognates and comparing the phased data segments of the plurality of cognates to identify, for each cognate, one of the phased data segments that is inherited from a target parent. The method further includes extracting, for each cognate, the phased data segment that is inherited from the target parent to form a set of cognate phased data segments that are inherited from the target parent. The method includes identifying data exchange breakpoints in the set of cognate phased data segments and reconstructing a pair of precursory phased data segments.

### CROSS-REFERENCE TO RELATED APPLICATIONS

The present application claims the benefit of U.S. Provisional Patent Application No. 63/593,867, filed on Oct. 27, 2023, and U.S. Provisional Patent Application No. 63/626,506, filed on Jan. 29, 2024, which is hereby incorporated by reference in its entirety.

### FIELD

The disclosed embodiments relate to reconstructing a precursory inheritance dataset from transferred data bits in successive datasets.

### BACKGROUND

Data-inheritance origins may be referred to as origins and describe how data may be inherited from real-world events. Data may be inherited and intermixed based on real-world events that are not always recorded or documented. Yet, while the real-world events may not be completely documented, the change and inheritance of those events may be traceable by comparing data strings among data instances. For example, two data instances may be generated independently and individually reflect the status of their respective named entities or events. The data patterns in the data instances may reflect the natures, histories, or characteristics of data inheritance sources such as related or unrelated named entities or events. However, multiple data instances or corresponding named entities or events may be inherited from one or more common sources so that the data instances share some similarities in the data pattern. As such, the nature of inheritance may be revealed by analyzing and comparing the multiple data instances, and sometimes a large number of data instances. Those real-life events that result in shared data strings among data instances may be referred to as data inheritance events, even though those real-life events, at the time of the occurrence, may not involve data or data generation at all. For example, the real-life events may be historical events that occurred before the invention of the computer or data but present data instances may still reflect those historical events.

### SUMMARY

In some embodiments, the disclosure described herein relate to a computer-implemented method for reconstructing precursory datasets, the computer-implemented method including: receiving a plurality of data instances from a plurality of cognates, each data instance corresponding to one of the cognates; phasing each data instance to generate a pair of phased datasets for each cognate of the plurality of cognates; comparing the phased datasets of the plurality of cognates to identify, for each cognate, one of the phased datasets that is inherited from a target precursor; extracting, for each cognate, the phased dataset that is inherited from the target precursor to form a set of cognate phased datasets that are inherited from the target precursor; identifying data exchange breakpoints in the set of cognate phased datasets, wherein identifying the data exchange breakpoints includes identifying locations of change in data agreement among the cognate phased datasets; and reconstructing a pair of precursory phased datasets by using one or more additional phased cognate datasets assessed for portions of dataset agreement and processed together through one or more optimization strategies to identify the most parsimonious explanation for the identified data exchange breakpoints.

In some embodiments, the disclosure described herein relates to a computer-readable storage medium having stored thereon computer-executable instructions that, when executed by one or more processors, cause the one or more processors to perform operations, including: receiving a plurality of data instances from a plurality of cognates, each data instance corresponding to one of the cognates; phasing each data instance to generate a pair of phased datasets for each cognate of the plurality of cognates; comparing the phased datasets of the plurality of cognates to identify, for each cognate, one of the phased datasets that is inherited from a target precursor; extracting, for each cognate, the phased dataset that is inherited from the target precursor to form a set of cognate phased datasets that are inherited from the target precursor; identifying data exchange breakpoints in the set of cognate phased datasets, wherein identifying the data exchange breakpoints includes identifying locations of change in data agreement among the cognate phased datasets; and reconstructing a pair of precursory phased datasets by using one or more additional phased cognate datasets assessed for portions of dataset agreement and processed together through one or more optimization strategies to identify the most parsimonious explanation for the identified data exchange breakpoints.

In some embodiments, the disclosure described herein relate to a computer system, including: one or more processors; and a hardware storage device having stored thereon computer-executable instructions that, when executed by the one or more processors, causes the computer system to perform operations, including: receiving a plurality of data instances from a plurality of cognates, each data instance corresponding to one of the cognates; phasing each data instance to generate a pair of phased datasets for each cognate of the plurality of cognates; comparing the phased datasets of the plurality of cognates to identify, for each cognate, one of the phased datasets that is inherited from a target precursor; extracting, for each cognate, the phased dataset that is inherited from the target precursor to form a set of cognate phased datasets that are inherited from the target precursor; identifying data exchange breakpoints in the set of cognate phased datasets, wherein identifying the data exchange breakpoints includes identifying locations of change in data agreement among the cognate phased datasets; and reconstructing a pair of precursory phased datasets by using one or more additional phased cognate datasets assessed for portions of dataset agreement and processed together through one or more optimization strategies to identify the most parsimonious explanation for the identified data exchange breakpoints.

In yet another embodiment, a non-transitory computer-readable medium that is configured to store instructions is described. The instructions, when executed by one or more processors, cause the one or more processors to perform a process that includes steps described in the above computer-implemented methods or described in any embodiments of this disclosure. In yet another embodiment, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

FIG. 1 illustrates a diagram of a system environment of an example computing system, in accordance with some embodiments.

FIG. 2 is a block diagram of an architecture of an example computing system, in accordance with some embodiments.

FIG. 3 is a flowchart depicting an example process for reconstructing a parent's haplotypes using three children's haplotypes, in accordance with some embodiments.

FIG. 4A illustrates an example of phasing a genetic dataset to obtain a pair of haplotypes for each sibling, in accordance with some embodiments.

FIG. 4B is a conceptual diagram graphically illustrating haplotypes of siblings that are inherited from a same parent, in accordance with some embodiments.

FIG. 4C illustrates an example portion of a set of sibling haplotypes, in accordance with some embodiments.

FIG. 4D is a conceptual diagram illustrating the process of reconstructing haplotypes of the target parent, in accordance with some embodiments.

FIG. 4E is a conceptual diagram graphically illustrating using a close relative's haplotypes to correlate a target parent's haplotypes across chromosomes, in accordance with some embodiments.

FIG. 5A is a conceptual diagram graphically illustrating using a distant relative's (as illustrated by a second cousin's) haplotypes to correlate a target parent's haplotypes across chromosomes, in accordance with some embodiments.

FIG. 5B illustrates an example information matrix, in accordance with some embodiments.

FIG. 6 is a flowchart depicting an example process for reconstructing a parent's haplotypes using two children's haplotypes, in accordance with some embodiments.

FIG. 7A is a conceptual diagram graphically illustrating using a relative's genotype data to determine a target parent, in accordance with some embodiments.

FIG. 7B shows an example portion of a set of sibling chromosome copies and IBD matches, in accordance with some embodiments.

FIG. 7C illustrates example phasing matrices, in accordance with some embodiments.

FIG. 7D shows an example portion of a set of sibling chromosome copies and possible alternative matches, in accordance with some embodiments.

FIG. 8 illustrates a structure of an example neural network, in accordance with some embodiments.

FIG. 9 is a block diagram of an example computing device, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTIONS

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Accurately and substantially reconstructing a parent's genome from a child's genome is a challenging task due to natural limitations in biological inheritance and the complexities of genetics. For example, while each child inherits half of their genetic data from each parent, the specific combination of transmitted genetic data is unique for each child. This means that one child's genome alone cannot provide a complete and accurate reconstruction of either parent's genome, 50% of the maternal or paternal alleles being inherited by any given child under normal circumstances. Additionally, in each generation, genetic data from both parents has undergone recombination when passed to the child, leading to genetic diversity among offspring but making it difficult to further reverse engineer a parent's genome by its own parentally inherited chromosome copies (such additional determination of the specific grandparent alleles present in a parent's reconstructed genome is known as a phased reconstruction, in contrast to the reformulation of parental alleles without such additional grandparental ordering known as unphased reconstruction). Previous methods have required having some genetic data for one of the two parents or having at least a partial pedigree for relatives having genetic data. Combined data from multiple children will theoretically contain increased information about a parent's genome, but disentangling these data to perform an accurate reconstruction for significant portions of the parent's genome from either few or many children genomes is a formidable task requiring an algorithmic strategy that can identify and reconstitute a multiplicity of uniquely mixed DNA sequences across all chromosomes.

Disclosed are techniques for reconstructing the genomes of both parents using the genomes of three or more children and also under a separate scenario from only two children. The children may be full siblings that share the same parents. Each sibling's genetic dataset is phased to generate pairs of chromosomal copies across the genome, each copy for each sibling containing the alleles that are inherited from a single parent, i.e., paternal or maternal parent. The method may then determine across the siblings, the chromosomal copies that were inherited from the same target parent to form a set of sibling chromosomal copies, each specific to a single parent. By comparing each set of sibling haplotypes to identify switch locations in agreement/disagreement of the haplotypes, one can identify recombination breakpoints within each chromosome. In some embodiments, using a voting process, the method may identify in which of the sibling haplotypes the recombination breakpoint was present and through coded logic, obtain an unphased (or locally phased) reconstructed genome of the parents in which each chromosomal copy is phased but uncorrelated across the chromosomes (i.e. which of the two chromosomal copies was inherited from the same parent across all of the chromosomes is unknown). In some embodiments, switches from agreement to disagreement regions (or vice versa) occurring across a chromosome or the entire genome can be used to identify the occurrence of recombination breakpoints without determining in which of the sibling haplotypes the recombination breakpoint was present, but still allow for the identification of an unphased reconstructed genome of the target parent by utilizing the identified information of whether one common haplotype or two haplotypes were observed in each region. Then, using the identification of which reconstructed chromosomal copy or region shares an identical haplotype portion with a single or additional relatives to a given parent, the method may incorporate an optimization strategy or a plurality of optimization strategies to further identify and re-group the chromosomal copies or regions of the reconstructed unphased genome according to inheritance from a same grandparent, thereby reconstructing the genome-wide (or long-range/inter-chromosomal) phased genome of a target parent.

Embodiments achieve a very high amount of reconstruction of both the unphased (or locally phased) and genome-wide phased parent genome, with mean amounts that are nearly identical to the expected average amount predicted to be transmitted to a set of children according to the laws of genetics and probability. Indeed, the disclosed embodiments achieve unprecedented success in terms of i) the amount of the parental genome that is reconstructed, ii) the ability to reconstruct the parental genome using, in some embodiments, only distant matches, iii) the speed at which reconstruction may be accomplished, iv) and the ability to recover the large proportion of parental genomes using an unprecedently low number of siblings, in embodiments as few as three siblings, and in embodiments as few as two siblings.

In yet another embodiment, e.g. when the genomes of only two or more children are available, an alternative algorithmic procedure is utilized which identifies regions of identical or non-identical haplotypes present in the siblings across a chromosome or the entire genome and through comparison deduces the unphased (or locally phased) genome of a target parent as a concatenation of regions having both alleles identified (i.e. for regions of non-identical haplotypes) and where only one allele is known with certainty (i.e. for regions of identical haplotypes). Then, with an additional algorithmic optimization procedure that combines information of the region agreement/disagreement between the two siblings together with identified regions having identical haplotypes with a single or additional relatives, a genome-wide (or long-range) phased reconstruction of the target parent genome is accomplished. That is, the method may include accessing the plurality of relative genetic datasets, identifying matchings between the relative chromosome datasets and the agreement and disagreement regions, and arranging, in a phasing matrix, the identified matchings. The phasing matrix assigns each agreement or disagreement region to a grandparent label in a manner that is initially accurate in a correlative sense but not necessarily accurate for absolute labels. The method may then reduce an overall discrepancy in absolute grandparent assignment across all distinct regions across all chromosomes through optimization and reconstruct a genome-wide phased genome reconstruction of the target parent.

### Example System Environment

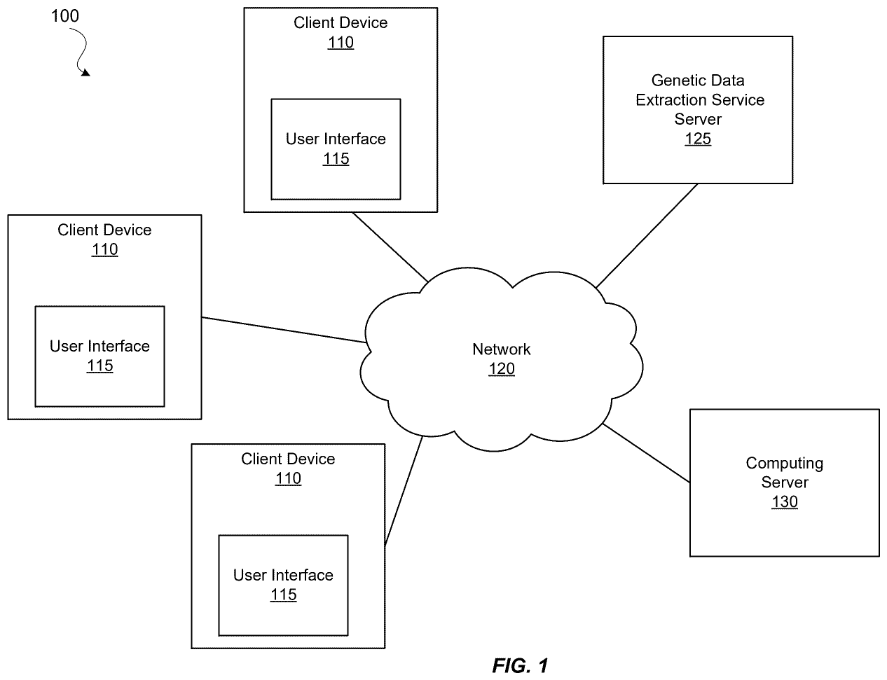

FIG. 1 illustrates a diagram of a system environment 100 of an example computing server 130, in accordance with some embodiments. The system environment 100 shown in FIG. 1 includes one or more client devices 110, a network 120, a genetic data extraction service server 125, and a computing server 130. In various embodiments, the system environment 100 may include fewer or additional components. The system environment 100 may also include different components.

The client devices 110 are one or more computing devices capable of receiving user input as well as transmitting and/or receiving data via a network 120. Example computing devices include desktop computers, laptop computers, personal digital assistants (PDAs), smartphones, tablets, wearable electronic devices (e.g., smartwatches), smart household appliances (e.g., smart televisions, smart speakers, smart home hubs), Internet of Things (IoT) devices or other suitable electronic devices. A client device 110 communicates to other components via the network 120. Users may be customers of the computing server 130 or any individuals who access the system of the computing server 130, such as an online website or a mobile application. In some embodiments, a client device 110 executes an application that launches a graphical user interface (GUI) for a user of the client device 110 to interact with the computing server 130. The GUI may be an example of a user interface 115. A client device 110 may also execute a web browser application to enable interactions between the client device 110 and the computing server 130 via the network 120. In another embodiment, the user interface 115 may take the form of a software application published by the computing server 130 and installed on the user device 110. In yet another embodiment, a client device 110 interacts with the computing server 130 through an application programming interface (API) running on a native operating system of the client device 110, such as IOS or ANDROID.

The network 120 provides connections to the components of the system environment 100 through one or more sub-networks, which may include any combination of local area and/or wide area networks, using both wired and/or wireless communication systems. In some embodiments, a network 120 uses standard communications technologies and/or protocols. For example, a network 120 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 120 may be represented using any suitable format, such as hypertext markup language (HTML) or extensible markup language (XML). In some embodiments, all or some of the communication links of a network 120 may be encrypted using any suitable technique or techniques such as secure sockets layer (SSL), transport layer security (TLS), virtual private networks (VPNs), Internet Protocol security (IPsec), etc. The network 120 also includes links and packet-switching networks such as the Internet.

Individuals, who may be customers of a company operating the computing server 130, provide biological samples for analysis of their genetic data. Individuals may also be referred to as users. In some embodiments, an individual uses a sample collection kit to provide a biological sample (e.g., saliva, blood, hair, tissue) from which genetic data is extracted and determined according to nucleotide processing techniques such as microarray, amplification and/or sequencing. Microarray may include immobilizing probe DNA sequences, onto a solid surface such as a glass slide. Target DNA samples, labeled with fluorescent tags, are then applied to the microarray surface. Through complementary base pairing, the labeled DNA binds to its corresponding probe on the microarray. By detecting the fluorescence emitted by the labeled DNA, genetic data may be extracted. Amplification may include using polymerase chain reaction (PCR) to amplify segments of nucleotide samples. Sequencing may include sequencing of deoxyribonucleic acid (DNA) sequencing, ribonucleic acid (RNA) sequencing, etc. Suitable sequencing techniques may include Sanger sequencing and massively parallel sequencing such as various next-generation sequencing (NGS) techniques including whole genome sequencing, whole exome sequencing, targeted sequencing, pyrosequencing, sequencing by synthesis, sequencing by ligation, and ion semiconductor sequencing. In some embodiments, a set of SNPs (e.g., 300,000) that are shared between different array platforms (e.g., Illumina OmniExpress Platform and Illumina HumanHap 650Y Platform) may be obtained as genetic data. Genetic data extraction service server 125 receives biological samples from users of the computing server 130. The genetic data extraction service server 125 extracts genetic data from the samples and the data may take the form of a set of SNPs. The genetic data extraction service server 125 generates the genetic data of the individuals based on sequencing or microarray results. The genetic data may include data generated from DNA or RNA and may include base pairs from coding and/or noncoding regions of DNA.

The genetic data may take different forms and include information regarding various biomarkers of an individual. For example, in some embodiments, the genetic data may be the base pair sequence of an individual. The base pair sequence may include the whole genome or a part of the genome such as certain genetic loci of interest. In another embodiment, the genetic data extraction service server 125 may determine genotypes from DNA identification results, for example by identifying genotype values of single nucleotide polymorphisms (SNPs) present within the DNA. The results in this example may include a sequence of genotypes corresponding to various SNP sites. A SNP site may also be referred to as a SNP loci. A genetic locus is a segment of a genetic sequence. A locus can be a single site or a longer stretch. The segment can be a single base long or multiple bases long. In some embodiments, the genetic data extraction service server 125 may perform data pre-processing of the genetic data to convert raw sequences of base pairs to sequences of genotypes at target SNP sites. Since a typical human genome may differ from a reference human genome at only several million SNP sites (as opposed to billions of base pairs in the whole genome), the genetic data extraction service server 125 may extract only the genotypes at a set of target SNP sites and transmit the extracted data to the computing server 130 as the inheritance dataset of an individual. SNPs, base pair sequences, genotypes, haplotypes, RNA sequences, protein sequences, and phenotypes are examples of biomarkers. In some embodiments, each SNP site may have two readings that are heterozygous.

The computing server 130 performs various analyses of the genetic data, genealogy data, and users' survey responses to generate results regarding the phenotypes and genealogy of users of computing server 130. Depending on the embodiments, the computing server 130 may also be referred to as an online server, a personal genetic service server, a genealogy server, a family tree building server, and/or a social networking system. The computing server 130 receives genetic data from the genetic data extraction service server 125 and stores the genetic data in the data store of the computing server 130. The computing server 130 may analyze the data to generate results regarding the genetics or genealogy of users. The results regarding the genetics or genealogy of users may include the ethnicity compositions of users, paternal and maternal genetic analysis, identification or suggestion of potential family relatives, ancestor information, analyses of DNA data, potential or identified traits such as phenotypes of users (e.g., diseases, appearance traits, other genetic characteristics, and other non-genetic characteristics including social characteristics), etc. The computing server 130 may present or cause the user interface 115 to present the results to the users through a GUI displayed on the client device 110. The results may include graphical elements, textual information, data, charts, and other elements such as family trees.

In some embodiments, the computing server 130 also allows various users to create one or more genealogical profiles of the user. The genealogical profile may include a list of individuals (e.g., ancestors, relatives, friends, and other people of interest) who are added or selected by the user or suggested by the computing server 130 based on the genealogical records and/or genetic records. The user interface 115 controlled by or in communication with the computing server 130 may display the individuals in a list or as a family tree such as in the form of a pedigree chart. In some embodiments, subject to the user's privacy setting and authorization, the computing server 130 may allow information generated from the user's inheritance dataset to be linked to the user profile and to one or more of the family trees. The users may also authorize the computing server 130 to analyze their inheritance dataset and allow their profiles to be discovered by other users.

### Example Computing Server Architecture

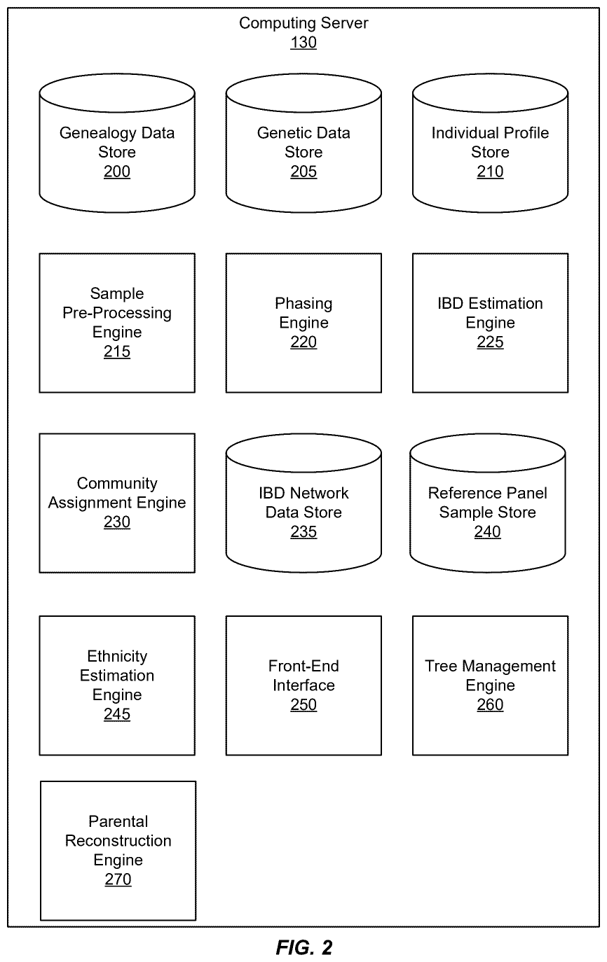

FIG. 2 is a block diagram of the architecture of an example computing server 130, in accordance with some embodiments. In the embodiment shown in FIG. 2, the computing server 130 includes a genealogy data store 200, a genetic data store 205, an individual profile store 210, a sample pre-processing engine 215, a phasing engine 220, an identity by descent (IBD) estimation engine 225, a community assignment engine 230, an IBD network data store 235, a reference panel sample store 240, an ethnicity estimation engine 245, a front-end interface 250, a tree management engine 260, and a parental reconstruction engine 270. The functions of the computing server 130 may be distributed among the elements in a different manner than described. In various embodiments, the computing server 130 may include different components and fewer or additional components. Each of the various data stores may be a single storage device, a server controlling multiple storage devices, or a distributed network that is accessible through multiple nodes (e.g., a cloud storage system).

The computing server 130 stores various data of different individuals, including genetic data, genealogy data, and survey response data. The computing server 130 processes the genetic data of users to identify shared identity-by-descent (IBD) segments between individuals. The genealogy data and survey response data may be part of user profile data. The amount and type of user profile data stored for each user may vary based on the information of a user, which is provided by the user as she creates an account and profile at a system operated by the computing server 130 and continues to build her profile, family tree, and social network at the system and to link her profile with her genetic data. Users may provide data via the user interface 115 of a client device 110. Initially and as a user continues to build her genealogical profile, the user may be prompted to answer questions related to the basic information of the user (e.g., name, date of birth, birthplace, etc.) and later on more advanced questions that may be useful for obtaining additional genealogy data. The computing server 130 may also include survey questions regarding various traits of the users such as the users' phenotypes, characteristics, preferences, habits, lifestyle, environment, etc.

Genealogy data may be stored in the genealogy data store 200 and may include various types of data that are related to tracing family relatives of users. Examples of genealogy data include names (first, last, middle, suffixes), gender, birth locations, date of birth, date of death, marriage information, spouse's information kinships, family history, dates and places for life events (e.g., birth and death), other vital data, and the like. In some instances, family history can take the form of a pedigree of an individual (e.g., the recorded relationships in the family). The family tree information associated with an individual may include one or more specified nodes. Each node in the family tree represents the individual, an ancestor of the individual who might have passed down genetic material to the individual, and the individual's other relatives including siblings, cousins, and offspring in some cases. Genealogy data may also include connections and relationships among users of the computing server 130. The information related to the connections between a user and her relatives that may be associated with a family tree may also be referred to as pedigree data or family tree data.

In addition to user-input data, genealogy data may also take other forms that are obtained from various sources such as public records and third-party data collectors. For example, genealogical records from public sources include birth records, marriage records, death records, census records, court records, probate records, adoption records, obituary records, etc. Likewise, genealogy data may include data from one or more family trees of an individual, the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, a motor vehicle database, and the like.

Furthermore, the genealogy data store 200 may also include relationship information inferred from the genetic data stored in the genetic data store 205 and information received from the individuals. For example, the relationship information may indicate which individuals are genetically related, how they are related, how many generations back they share common ancestors, lengths and locations of IBD segments shared, which genetic communities an individual is a part of, variants carried by the individual, and the like.

The computing server 130 maintains inheritance datasets of individuals in the genetic data store 205. An inheritance dataset of an individual may be a digital dataset of nucleotide data (e.g., SNP data) and corresponding metadata. For example, an inheritance dataset may be genetic data extracted by the genetic data extraction service server 125. An inheritance dataset may contain data on the whole or portions of an individual's genome. The genetic data store 205 may store a pointer to a location associated with the genealogy data store 200 associated with the individual. An inheritance dataset may take different forms. In some embodiments, an inheritance dataset may take the form of a base pair sequence of the sequencing result of an individual. A base pair sequence dataset may include the whole genome of the individual (e.g., obtained from a whole-genome sequencing) or some parts of the genome (e.g., genetic loci of interest). A microarray data may take the form of SNP data at target positions in the genome.

In another embodiment, an inheritance dataset may take the form of sequences of genetic markers. Examples of genetic markers may include target SNP sites (e.g., allele sites) filtered from the DNA identification results. A SNP site that is a single base pair long may also be referred to as a SNP locus. A SNP site may be associated with a unique identifier. The inheritance dataset may be in the form of diploid data that includes a sequence of genotypes, such as genotypes at the target SNP site, or the whole base pair sequence that includes genotypes at known SNP sites and other base pair sites that are not commonly associated with known SNPs. The diploid dataset may be referred to as a genotype dataset or a genotype sequence. Genotype may have a different meaning in various contexts. In one context, an individual's genotype may refer to a collection of diploid alleles of an individual. In other contexts, a genotype may be a pair of alleles present on two chromosomes for an individual at a given genetic marker such as a SNP site.

Genotype data for a SNP site may include a pair of alleles. The pair of alleles may be homozygous (e.g., A-A or G-G) or heterozygous (e.g., A-T, C-T). Instead of storing the actual nucleotides, the genetic data store 205 may store genetic data that are converted to bits. For a given SNP site, oftentimes only two nucleotide alleles (instead of all 4) are observed. As such, a 2-bit number may represent a SNP site. For example, 00 may represent homozygous first alleles, 11 may represent homozygous second alleles, and 01 or 10 may represent heterozygous alleles. A separate library may store what nucleotide corresponds to the first allele and what nucleotide corresponds to the second allele at a given SNP site.

A diploid dataset may also be phased into two sets of haploid data, one corresponding to a first parent side and another corresponding to a second parent side. The phased datasets may be referred to as haplotype datasets or haplotype sequences. Similar to genotype, haplotype may have a different meaning in various contexts. In one context, a haplotype may also refer to a collection of alleles that corresponds to a genetic segment. In other contexts, a haplotype may refer to a specific allele at a SNP site. For example, a sequence of haplotypes may refer to a sequence of alleles of an individual that are inherited from a parent.

The individual profile store 210 stores profiles and related metadata associated with various individuals appeared in the computing server 130. A computing server 130 may use unique individual identifiers to identify various users and other non-users that might appear in other data sources such as ancestors or historical persons who appear in any family tree or genealogy database. A unique individual identifier may be a hash of certain identification information of an individual, such as a user's account name, user's name, date of birth, location of birth, or any suitable combination of the information. The profile data related to an individual may be stored as metadata associated with an individual's profile. For example, the unique individual identifier and the metadata may be stored as a key-value pair using the unique individual identifier as a key.

An individual's profile data may include various kinds of information related to the individual. The metadata about the individual may include one or more pointers associating inheritance datasets such as genotype and phased haplotype data of the individual that are saved in the genetic data store 205. The metadata about the individual may also be individual information related to family trees and pedigree datasets that include the individual. The profile data may further include declarative information about the user that was authorized by the user to be shared and may also include information inferred by the computing server 130. Other examples of information stored in a user profile may include biographic, demographic, and other types of descriptive information such as work experience, educational history, gender, hobbies, preferences, location and the like. In some embodiments, the user profile data may also include one or more photos of the users and photos of relatives (e.g., ancestors) of the users that are uploaded by the users. A user may authorize the computing server 130 to analyze one or more photos to extract information, such as the user's or relative's appearance traits (e.g., blue eyes, curved hair, etc.), from the photos. The appearance traits and other information extracted from the photos may also be saved in the profile store. In some cases, the computing server may allow users to upload many different photos of the users, their relatives, and even friends. User profile data may also be obtained from other suitable sources, including historical records (e.g., records related to an ancestor), medical records, military records, photographs, other records indicating one or more traits, and other suitable recorded data.

For example, the computing server 130 may present various survey questions to its users from time to time. The responses to the survey questions may be stored at individual profile store 210. The survey questions may be related to various aspects of the users and the users' families. Some survey questions may be related to users' phenotypes, while other questions may be related to the environmental factors of the users.

Survey questions may concern health or disease-related phenotypes, such as questions related to the presence or absence of genetic diseases or disorders, inheritable diseases or disorders, or other common diseases or disorders that have a family history as one of the risk factors, questions regarding any diagnosis of increased risk of any diseases or disorders, and questions concerning wellness-related issues such as a family history of obesity, family history of causes of death, etc. The diseases identified by the survey questions may be related to single-gene diseases or disorders that are caused by a single-nucleotide variant, an insertion, or a deletion. The diseases identified by the survey questions may also be multifactorial inheritance disorders that may be caused by a combination of environmental factors and genes. Examples of multifactorial inheritance disorders may include heart disease, Alzheimer's disease, diabetes, cancer, and obesity. The computing server 130 may obtain data on a user's disease-related phenotypes from survey questions about the health history of the user and her family and also from health records uploaded by the user.

Survey questions also may be related to other types of phenotypes such as appearance traits of the users. A survey regarding appearance traits and characteristics may include questions related to eye color, iris pattern, freckles, chin types, finger length, dimple chin, earlobe types, hair color, hair curl, skin pigmentation, susceptibility to skin burn, bitter taste, male baldness, baldness pattern, presence of unibrow, presence of wisdom teeth, height, and weight. A survey regarding other traits also may include questions related to users' taste and smell such as the ability to taste bitterness, asparagus smell, cilantro aversion, etc. A survey regarding traits may further include questions related to users' body conditions such as lactose tolerance, caffeine consumption, malaria resistance, norovirus resistance, muscle performance, alcohol flush, etc. Other survey questions regarding a person's physiological or psychological traits may include vitamin traits and sensory traits such as the ability to sense an asparagus metabolite. Traits may also be collected from historical records, electronic health records and electronic medical records.

The computing server 130 also may present various survey questions related to the environmental factors of users. In this context, an environmental factor may be a factor that is not directly connected to the genetics of the users. Environmental factors may include users' preferences, habits, and lifestyles. For example, a survey regarding users' preferences may include questions related to things and activities that users like or dislike, such as types of music a user enjoys, dancing preference, party-going preference, certain sports that a user plays, video game preferences, etc. Other questions may be related to the users' diet preferences such as like or dislike a certain type of food (e.g., ice cream, egg). A survey related to habits and lifestyle may include questions regarding smoking habits, alcohol consumption and frequency, daily exercise duration, sleeping habits (e.g., morning person versus night person), sleeping cycles and problems, hobbies, and travel preferences. Additional environmental factors may include diet amount (calories, macronutrients), physical fitness abilities (e.g., stretching, flexibility, heart rate recovery), family type (adopted family or not, has siblings or not, lived with extended family during childhood), property and item ownership (has home or rents, has a smartphone or doesn't, has a car or doesn't).

Surveys also may be related to other environmental factors such as geographical, social-economic, or cultural factors. Geographical questions may include questions related to the birth location, family migration history, town, or city of users' current or past residence. Social-economic questions may be related to users' education level, income, occupations, self-identified demographic groups, etc. Questions related to culture may concern users' native language, language spoken at home, customs, dietary practices, etc. Other questions related to users' cultural and behavioral questions are also possible.

For any survey questions asked, the computing server 130 may also ask an individual the same or similar questions regarding the traits and environmental factors of the ancestors, family members, other relatives or friends of the individual. For example, a user may be asked about the native language of the user and the native languages of the user's parents and grandparents. A user may also be asked about the health history of his or her family members.

In addition to storing the survey data in the individual profile store 210, the computing server 130 may store some responses that correspond to data related to genealogical and genetics respectively to genealogy data store 200 and genetic data store 205.

The user profile data, photos of users, survey response data, the genetic data, and the genealogy data may be subject to the privacy and authorization setting of the users to specify any data related to the users that can be accessed, stored, obtained, or otherwise used. For example, when presented with a survey question, a user may select to answer or skip the question. The computing server 130 may present users from time to time information regarding users' selection of the extent of information and data shared. The computing server 130 also may maintain and enforce one or more privacy settings for users in connection with the access of the user profile data, photos, genetic data, and other sensitive data. For example, the user may pre-authorize the access to the data and may change the setting as wished. The privacy settings also may allow a user to specify (e.g., by opting out, by not opting in) whether the computing server 130 may receive, collect, log, or store particular data associated with the user for any purpose. A user may restrict her data at various levels. For example, on one level, the data may not be accessed by the computing server 130 for purposes other than displaying the data in the user's own profile. On another level, the user may authorize anonymization of her data and participate in studies and research conducted by the computing server 130 such as a large-scale genetic study. On yet another level, the user may turn some portions of her genealogy data public to allow the user to be discovered by other users (e.g., potential relatives) and be connected to one or more family trees. Access or sharing of any information or data in the computing server 130 may also be subject to one or more similar privacy policies. A user's data and content objects in the computing server 130 may also be associated with different levels of restriction. The computing server 130 may also provide various notification features to inform and remind users of their privacy and access settings. For example, when privacy settings for a data entry allow a particular user or other entities to access the data, the data may be described as being “visible,” “public,” or other suitable labels, contrary to a “private” label.

In some cases, the computing server 130 may have heightened privacy protection on certain types of data and data related to certain vulnerable groups. In some cases, the heightened privacy settings may strictly prohibit the use, analysis, and sharing of data related to a certain vulnerable group. In other cases, the heightened privacy settings may specify that data subject to those settings require prior approval for access, publication, or other use. In some cases, the computing server 130 may provide heightened privacy as a default setting for certain types of data, such as genetic data or any data that the user marks as sensitive. The user may opt in to sharing those data or change the default privacy settings. In other cases, the heightened privacy settings may apply across the board for all data of certain groups of users. For example, if computing server 130 determines that the user is a minor or has recognized that a picture of a minor is uploaded, the computing server 130 may designate all profile data associated with the minor as sensitive. In those cases, the computing server 130 may have one or more extra steps in seeking and confirming any sharing or use of the sensitive data.

In some embodiments, the individual profile store 210 may be a large-scale data store. In some embodiments, the individual profile store 210 may include at least 10,000 data records in the form of user profiles and each user profile may be associated with one or more inheritance datasets and one or more genealogical data entries. In some embodiments, the individual profile store 210 may include at least 50,000 data records in the form of user profiles and each user profile may be associated with one or more inheritance datasets and one or more genealogical data entries. In some embodiments, the individual profile store 210 may include at least 100,000 data records in the form of user profiles and each user profile may be associated with one or more inheritance datasets and one or more genealogical data entries. In some embodiments, the individual profile store 210 may include at least 500,000 data records in the form of user profiles and each user profile may be associated with one or more inheritance datasets and one or more genealogical data entries. In some embodiments, the individual profile store 210 may include at least 1,000,000 data records in the form of user profiles and each user profile may be associated with one or more inheritance datasets and one or more genealogical data entries. In some embodiments, the individual profile store 210 may include at least 2,000,000 data records in the form of user profiles and each user profile may be associated with one or more inheritance datasets and one or more genealogical data entries. In some embodiments, the individual profile store 210 may include at least 5,000,000 data records in the form of user profiles and each user profile may be associated with one or more inheritance datasets and one or more genealogical data entries. In some embodiments, the individual profile store 210 may include at least 10,000,000 data records in the form of user profiles and each user profile may be associated with one or more inheritance datasets and one or more genealogical data entries.

The sample pre-processing engine 215 receives and pre-processes data received from various sources to change the data into a format used by the computing server 130. For genealogy data, the sample pre-processing engine 215 may receive data from an individual via the user interface 115 of the client device 110. To collect the user data (e.g., genealogical and survey data), the computing server 130 may cause an interactive user interface on the client device 110 to display interface elements in which users can provide genealogy data and survey data. Additional data may be obtained from scans of public records. The data may be manually provided or automatically extracted via, for example, optical character recognition (OCR) performed on census records, town or government records, or any other item of printed or online material. Some records may be obtained by digitalizing written records such as older census records, birth certificates, death certificates, etc.

The sample pre-processing engine 215 may also receive raw data from the genetic data extraction service server 125. The genetic data extraction service server 125 may perform laboratory analysis of biological samples of users and generate sequencing results in the form of digital data. The sample pre-processing engine 215 may receive the raw inheritance datasets from the genetic data extraction service server 125. Most of the mutations that are passed down to descendants are related to single-nucleotide polymorphism (SNP). SNP is a substitution of a single nucleotide that occurs at a specific position in the genome. The sample pre-processing engine 215 may convert the raw base pair sequence into a sequence of genotypes of target SNP sites. Alternatively, the pre-processing of this conversion may be performed by the genetic data extraction service server 125. The sample pre-processing engine 215 identifies autosomal SNPs in an individual's inheritance dataset. In some embodiments, the SNPs may be autosomal SNPs. In some embodiments, 700,000 SNPs may be identified in an individual's data and may be stored in genetic data store 205. Alternatively, in some embodiments, an inheritance dataset may include at least 10,000 SNP sites. In another embodiment, an inheritance dataset may include at least 100,000 SNP sites. In yet another embodiment, an inheritance dataset may include at least 300,000 SNP sites. In yet another embodiment, an inheritance dataset may include at least 1,000,000 SNP sites. In yet another embodiment, an inheritance dataset may include at least 30,000,000 SNP sites. In yet another embodiment, an inheritance dataset may include at least 600,000,000 SNP sites. The sample pre-processing engine 215 may also convert the nucleotides into bits. The identified SNPs, in bits or in other suitable formats, may be provided to the phasing engine 220 which phases the individual's diploid genotypes to generate a pair of haplotypes for each user.

The phasing engine 220 phases a diploid inheritance dataset into a pair of haploid inheritance datasets and may perform imputation of SNP values at certain sites whose alleles are missing. An individual's haplotype may refer to a collection of alleles (e.g., a sequence of alleles) that are inherited from a parent.

Phasing may include a process of determining the assignment of alleles (particularly heterozygous alleles) to chromosomes. Owing to conditions and other constraints in sequencing or microarray, a DNA identification result often includes data regarding a pair of alleles at a given SNP locus of a pair of chromosomes but may not be able to distinguish which allele belongs to which specific chromosome. The phasing engine 220 uses a genotype phasing algorithm to assign one allele to a first chromosome and another allele to another chromosome. The genotype phasing algorithm may be developed based on an assumption of linkage disequilibrium (LD), which states that haplotype in the form of a sequence of alleles tends to cluster together. The phasing engine 220 is configured to generate phased sequences that are also commonly observed in many other samples. Put differently, haplotype sequences of different individuals tend to cluster together. A haplotype-cluster model may be generated to determine the probability distribution of a haplotype that includes a sequence of alleles. The haplotype-cluster model may be trained based on labeled data that includes known phased haplotypes from a trio (parents and a child). A trio is used as a training sample because the correct phasing of the child is almost certain by comparing the child's genotypes to the parent's inheritance datasets. The haplotype-cluster model may be generated iteratively along with the phasing process with a large number of unphased genotype datasets. The haplotype-cluster model may also be used to impute one or more missing data.

By way of example, the phasing engine 220 may use a directed acyclic graph model such as a hidden Markov model (HMM) to perform the phasing of a target genotype dataset. The directed acyclic graph may include multiple levels, each level having multiple nodes representing different possibilities of haplotype clusters. An emission probability of a node, which may represent the probability of having a particular haplotype cluster given an observation of the genotypes may be determined based on the probability distribution of the haplotype-cluster model. A transition probability from one node to another may be initially assigned to a non-zero value and be adjusted as the directed acyclic graph model and the haplotype-cluster model are trained. Various paths are possible in traversing different levels of the directed acyclic graph model. The phasing engine 220 determines a statistically likely path, such as the most probable path or a probable path that is at least more likely than 95% of other possible paths, based on the transition probabilities and the emission probabilities. A suitable dynamic programming algorithm such as the Viterbi algorithm may be used to determine the path. The determined path may represent the phasing result. U.S. Pat. No. 10,679,729, entitled “Haplotype Phasing Models,” granted on Jun. 9, 2020, describes example embodiments of haplotype phasing.

A phasing algorithm may also generate phasing result that has a long genomic distance accuracy and cross-chromosome accuracy in terms of haplotype separation. For example, in some embodiments, an IBD-phasing algorithm may be used, which is described in further detail in U.S. Patent Application Publication No. US 2021/0034647, entitled “Clustering of Matched Segments to Determine Linkage of Dataset in a Database,” published on Feb. 4, 2021. For example, the computing server 130 may receive a target individual genotype dataset and a plurality of additional individual genotype datasets that include haplotypes of additional individuals. For example, the additional individuals may be reference panels or individuals who are linked (e.g., in a family tree) to the target individual. The computing server 130 may generate a plurality of sub-cluster pairs of first parental groups and second parental groups. Each sub-cluster pair may be in a window. The window may correspond to a genomic segment and has a similar concept of window used in the ethnicity estimation engine 245 and the rest of the disclosure related to HMMs, but how windows are precisely divided and defined may be the same or different in the phasing engine 220 and in an HMM. Each sub-cluster pair may correspond to a genetic locus. In some embodiments, each sub-cluster pair may have a first parental group that includes a first set of matched haplotype segments selected from the plurality of additional individual datasets and a second parental group that includes a second set of matched haplotype segments selected from the plurality of additional individual datasets. The computing server 130 may generate a super-cluster of a parental side by linking the first parental groups and the second parental groups across a plurality of genetic loci (across a plurality of sub-cluster pairs). Generating the super-cluster of the parental side may include generating a candidate parental side assignment of parental groups across a set of sub-cluster pairs that represent a set of genetic loci in the plurality of genetic loci. The computing server 130 may determine the number of common additional individual genotype datasets that are classified in the candidate parental side assignment. The computing server 130 may determine the candidate parental side assignment to be part of the super-cluster based on the number of common additional individual genotype datasets. Any suitable algorithms may be used to generate the super-cluster, such as a heuristic scoring approach, a bipartite graph approach, or another suitable approach. The computing server 130 may generate a haplotype phasing of the target individual from the super-cluster of the parental side.

The IBD estimation engine 225 estimates the amount of shared genetic segments between a pair of individuals based on phased genotype data (e.g., haplotype datasets) that are stored in the genetic data store 205. IBD segments may be segments identified in a pair of individuals that are putatively determined to be inherited from a common ancestor. The IBD estimation engine 225 retrieves a pair of haplotype datasets for each individual. The IBD estimation engine 225 may divide each haplotype dataset sequence into a plurality of windows. Each window may include a fixed number of SNP sites (e.g., about 100 SNP sites). The IBD estimation engine 225 identifies one or more seed windows in which the alleles at all SNP sites in at least one of the phased haplotypes between two individuals are identical. The IBD estimation engine 225 may expand the match from the seed windows to nearby windows until the matched windows reach the end of a chromosome or until a homozygous mismatch is found, which indicates the mismatch is not attributable to potential errors in phasing or imputation. The IBD estimation engine 225 determines the total length of matched segments, which may also be referred to as IBD segments. The length may be measured in the genetic distance in the unit of centimorgans (cM). A unit of centimorgan may be a genetic length. For example, two genomic positions that are one cM apart may have a 1% chance during each meiosis of experiencing a recombination event between the two positions. The computing server 130 may save data regarding individual pairs who share a length of IBD segments exceeding a predetermined threshold (e.g., 6 cM), in a suitable data store such as in the genealogy data store 200. U.S. Pat. No. 10,114,922, entitled “Identifying Ancestral Relationships Using a Continuous stream of Input,” granted on Oct. 30, 2018, and U.S. Pat. No. 10,720,229, entitled “Reducing Error in Predicted Genetic Relationships,” granted on Jul. 21, 2020, describe example embodiments of IBD estimation.

Typically, individuals who are closely related share a relatively large number of IBD segments, and the IBD segments tend to have longer lengths (individually or in aggregate across one or more chromosomes). In contrast, individuals who are more distantly related share relatively fewer IBD segments, and these segments tend to be shorter (individually or in aggregate across one or more chromosomes). For example, second to third cousins or more distantly related individuals may share less than 340 cM of IBD, while more closely related individuals may share more than this amount of IBD. The extent of relatedness in terms of IBD segments between two individuals may be referred to as IBD affinity. For example, the IBD affinity may be measured in terms of the length of IBD segments shared between two individuals.

Community assignment engine 230 assigns individuals to one or more genetic communities based on the genetic data of the individuals. A genetic community may correspond to an ethnic origin or a group of people descended from a common ancestor. The granularity of genetic community classification may vary depending on embodiments and methods used to assign communities. For example, in some embodiments, the communities may be African, Asian, European, etc. In another embodiment, the European community may be divided into Irish, German, Swedes, etc. In yet another embodiment, the Irish may be further divided into Irish in Ireland, Irish who immigrated to America in 1800, Irish who immigrated to America in 1900, etc. The community classification may also depend on whether a population is admixed or unadmixed. For an admixed population, the classification may further be divided based on different ethnic origins in a geographical region.

Community assignment engine 230 may assign individuals to one or more genetic communities based on their inheritance datasets using machine learning models trained by unsupervised learning or supervised learning. In an unsupervised approach, the community assignment engine 230 may generate data representing a partially connected undirected graph. In this approach, the community assignment engine 230 represents individuals as nodes. Some nodes are connected by edges whose weights are based on IBD affinity between two individuals represented by the nodes. For example, if the total length of two individuals' shared IBD segments does not exceed a predetermined threshold, the nodes are not connected. The edges connecting two nodes are associated with weights that are measured based on the IBD affinities. The undirected graph may be referred to as an IBD network. The community assignment engine 230 uses clustering techniques such as modularity measurement (e.g., the Louvain method) to classify nodes into different clusters in the IBD network. Each cluster may represent a community. The community assignment engine 230 may also determine sub-clusters, which represent sub-communities. The computing server 130 saves the data representing the IBD network and clusters in the IBD network data store 235. U.S. Pat. No. 10,223,498, entitled “Discovering Population Structure from Patterns of Identity-By-Descent,” granted on Mar. 5, 2019, describes example embodiments of community detection and assignment.

The community assignment engine 230 may also assign communities using supervised techniques. For example, inheritance datasets of known genetic communities (e.g., individuals with confirmed ethnic origins) may be used as training sets that have labels of the genetic communities. Supervised machine learning classifiers, such as logistic regressions, support vector machines, random forest classifiers, and neural networks may be trained using the training set with labels. A trained classifier may distinguish binary or multiple classes. For example, a binary classifier may be trained for each community of interest to determine whether a target individual's inheritance dataset belongs or does not belong to the community of interest. A multi-class classifier such as a neural network may also be trained to determine whether the target individual's inheritance dataset most likely belongs to one of several possible genetic communities.

Reference panel sample store 240 stores reference panel samples for different genetic communities. A reference panel sample is the genetic data of an individual whose genetic data is the most representative of a genetic community. The genetic data of individuals with the typical alleles of a genetic community may serve as reference panel samples. For example, some alleles of genes may be over-represented (e.g., being highly common) in a genetic community. Some inheritance datasets include alleles that are commonly present among members of the community. Reference panel samples may be used to train various machine learning models in classifying whether a target inheritance dataset belongs to a community, determining the ethnic composition of an individual, and determining the accuracy of any genetic data analysis, such as by computing a posterior probability of a classification result from a classifier.

A reference panel sample may be identified in different ways. In some embodiments, an unsupervised approach in community detection may apply the clustering algorithm recursively for each identified cluster until the sub-clusters contain a number of nodes that are smaller than a threshold (e.g., containing fewer than 1000 nodes). For example, the community assignment engine 230 may construct a full IBD network that includes a set of individuals represented by nodes and generate communities using clustering techniques. The community assignment engine 230 may randomly sample a subset of nodes to generate a sampled IBD network. The community assignment engine 230 may recursively apply clustering techniques to generate communities in the sampled IBD network. The sampling and clustering may be repeated for different randomly generated IBD networks for various runs. Nodes that are consistently assigned to the same genetic community when sampled in various runs may be classified as a reference panel sample. The community assignment engine 230 may measure the consistency in terms of a predetermined threshold. For example, if a node is classified to the same community 95% (or another suitable threshold) of the times the node is sampled, the inheritance dataset corresponding to the individual represented by the node may be regarded as a reference panel sample. Additionally, or alternatively, the community assignment engine 230 may select N most consistently assigned nodes as a reference panel for the community.

Other ways to generate reference panel samples are also possible. For example, the computing server 130 may collect a set of samples and gradually filter and refine the samples until high-quality reference panel samples are selected. For example, a candidate reference panel sample may be selected from an individual whose recent ancestors were born at a certain birthplace. The computing server 130 may also draw sequence data from the Human Genome Diversity Project (HGDP). Various candidates may be manually screened based on their family trees, relatives' birth location, and other quality controls. Principal component analysis may be used to create clusters of genetic data of the candidates. Each cluster may represent an ethnicity. The predictions of the ethnicity of those candidates may be compared to the ethnicity information provided by the candidates to perform further screening.

The ethnicity estimation engine 245 estimates the ethnicity composition of an inheritance dataset of a target individual. The inheritance datasets used by the ethnicity estimation engine 245 may be genotype datasets or haplotype datasets. For example, the ethnicity estimation engine 245 estimates the ancestral origins (e.g., ethnicity) based on the individual's genotypes or haplotypes at the SNP sites. To take a simple example of three ancestral populations corresponding to African, European and Native American, an admixed user may have nonzero estimated ethnicity proportions for all three ancestral populations, with an estimate such as [0.05, 0.5, 0.30], indicating that the user's genome is 5% attributable to African ancestry, 65% attributable to European ancestry and 30% attributable to Native American ancestry. The ethnicity estimation engine 245 generates the ethnic composition estimate and stores the estimated ethnicities in a data store of computing server 130 with a pointer in association with a particular user.

In some embodiments, the ethnicity estimation engine 245 divides a target inheritance dataset into a plurality of windows (e.g., about 1000 windows). Each window includes a small number of SNPs (e.g., 300 SNPs). The ethnicity estimation engine 245 may use a directed acyclic graph model to determine the ethnic composition of the target inheritance dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 245 determines the emission probabilities by comparing SNPs in the window corresponding to the target inheritance dataset to corresponding SNPs in the windows in various reference panel samples of different genetic communities stored in the reference panel sample store 240. The transition probability between two nodes represents the likelihood of transition from one node to another across two levels. The ethnicity estimation engine 245 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 245 determines the ethnic composition of the target inheritance dataset by determining the label compositions of the nodes that are included in the determined path. U.S. Pat. No. 10,558,930, entitled “Local Genetic Ethnicity Determination System,” granted on Feb. 11, 2020, and U.S. Pat. No. 10,692,587, granted on Jun. 23, 2020, entitled “Global Ancestry Determination System” describe different example embodiments of ethnicity estimation.

The tree management engine 260 performs computations and other processes related to users' management of their data trees such as family trees. The tree management engine 260 may allow a user to build a data tree from scratch or to link the user to existing data trees. In some embodiments, the tree management engine 260 may suggest a connection between a target individual and a family tree that exists in the family tree database by identifying potential family trees for the target individual and identifying one or more most probable positions in a potential family tree. A user (target individual) may wish to identify family trees to which he or she may potentially belong. Linking a user to a family tree or building a family may be performed automatically, manually, or using techniques with a combination of both. In an embodiment of an automatic tree matching, the tree management engine 260 may receive an inheritance dataset from the target individual as input and search related individuals that are IBD-related to the target individual. The tree management engine 260 may identify common ancestors. Each common ancestor may be common to the target individual and one of the related individuals. The tree management engine 260 may in turn output potential family trees to which the target individual may belong by retrieving family trees that include a common ancestor and an individual who is IBD-related to the target individual. The tree management engine 260 may further identify one or more probable positions in one of the potential family trees based on information associated with matched genetic data between the target individual and those in the potential family trees through one or more machine learning models or other heuristic algorithms. For example, the tree management engine 260 may try putting the target individual in various possible locations in the family tree and determine the highest probability position(s) based on the inheritance dataset of the target individual and inheritance datasets available for others in the family tree and based on genealogy data available to the tree management engine 260. The tree management engine 260 may provide one or more family trees from which the target individual may select. For a suggested family tree, the tree management engine 260 may also provide information on how the target individual is related to other individuals in the tree. In a manual tree building, a user may browse through public family trees and public individual entries in the genealogy data store 200 and individual profile store 210 to look for potential relatives that can be added to the user's family tree. The tree management engine 260 may automatically search, rank, and suggest individuals for the user to conduct manual reviews as the user makes progress in the front-end interface 250 in building the family tree.

As used herein, “pedigree” and “family tree” may be interchangeable and may refer to a family tree chart or pedigree chart that shows, diagrammatically, family information, such as family history information, including parentage, offspring, spouses, siblings, or otherwise for any suitable number of generations and/or people, and/or data pertaining to persons represented in the chart. U.S. Pat. No. 11,429,615, entitled “Linking Individual Datasets to a Database,” granted on Aug. 30, 2022, describes example embodiments of how an individual may be linked to existing family trees.

The front-end interface 250 may render a front-end platform that displays various results determined by the computing server 130. The platform may take the form of a genealogy research and family tree building platform and/or a personal DNA data analysis platform. The platform may also serve as a social networking system that allows users and connect and build family trees and research family relations together. The results and data may include the IBD affinity between a user and another individual, the community assignment of the user, the ethnicity estimation of the user, phenotype prediction and evaluation, genealogy data search, family tree and pedigree, relative profile and other information. The front-end interface 250 may allow users to manage their profile and data trees (e.g., family trees). The users may view various public family trees stored in the computing server 130 and search for individuals and their genealogy data via the front-end interface 250. The computing server 130 may suggest or allow the user to manually review and select potentially related individuals (e.g., relatives, ancestors, close family members) to add to the user's data tree. The front-end interface 250 may be a graphical user interface (GUI) that displays various information and graphical elements.

The front-end interface 250 may take different forms. In one case, the front-end interface 250 may be a software application that can be displayed on an electronic device such as a computer or a smartphone. The software application may be developed by the entity controlling the computing server 130 and be downloaded and installed on the client device 110. In another case, the front-end interface 250 may take the form of a webpage interface of the computing server 130 that allows users to access their family tree and genetic analysis results through web browsers. In yet another case, the front-end interface 250 may provide an application program interface (API). In some embodiments, the front-end interface 250 may be rendered as part of the content in an extended reality device, such as a head-mounted display or a phone camera that is integrated with augmented reality features.

The front-end interface 250 may provide various front-end visualization features. In some embodiments, a family tree viewer may render family tree built by users and/or managed by the tree management engine 260. The family tree may be displayed in a nested nodes and edges connected based on family relationships or genetic matches determined by various genetic data analysis engines discussed in FIG. 2. The family trees may include attached records that are part of records in the genealogy data store 200, including records that are uploaded by users and gallery images. The user may assign a focal person to a family tree and the family tree is displayed with the focus (such as positioning the focal person at the center or relative prominent position of the tree) around the focal person. A user may change the focal person and the family tree may shift accordingly based on the relationships and relative positions of members in the family tree. Each person in the family tree may be associated with historical photos from gallery images, historical genealogy records such as life event records, one or more stories and live events associated with the person, and metadata such as family relationships and other family trees associated with the person.

In some embodiments, visualization features provided by the front-end interface 250 may include a map feature. A map may be a geographical map that may take the form of a digital map, a historical physical map, and/or a historical map overlaid on a digital map. A user may select a geographical location and the front-end interface 250 displays relevant genealogical or genetic records associated with the location, such as an ancestor's lifetime events, birth locations of DNA matches, mitigation patterns of ancestors across different locations over time and associated genealogical records, residence maps that provide specific locations of historical persons' events, and historical maps overlaying on a digital map to contextualize ancestors' records and events. The map feature may also provide interactive features to allow users to view historical documents, photographs, and stores associated with the geographical locations. The map feature may also allow users to adjust timeframes, displaying changes in locations and migrations over different periods.

In some embodiments, visualization features provided by the front-end interface 250 may include a story feature that provides multimedia narratives about a person, such as the person's live events and family history. The story feature allows a user to compile various graphical and genealogical elements such as photos, documents, historical records, and personal anecdotes into a timeline to summarize a narrative. The story may be arranged in an appropriate spatial manner such as a linear arrangement that arranges various graphical elements based on the creator's selection. User data may be identified for use in a parental reconstruction engine 270. When appropriate, genetic data from multiple siblings and other relatives may be combined to reconstruct parental genetic data. The methods of the engine 270 that computes these data are described herein.

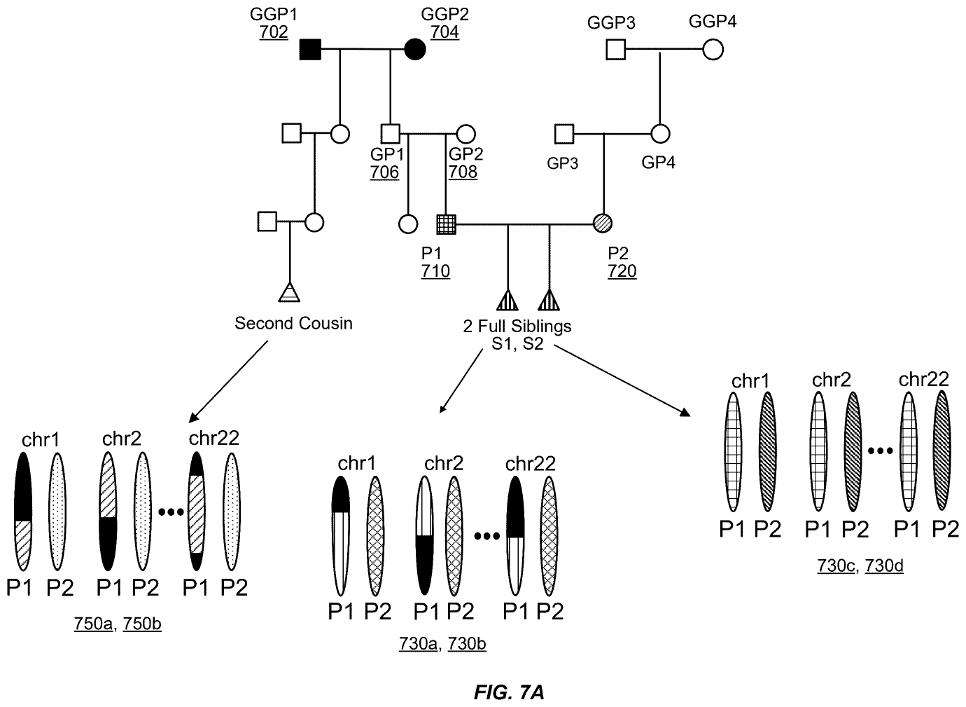

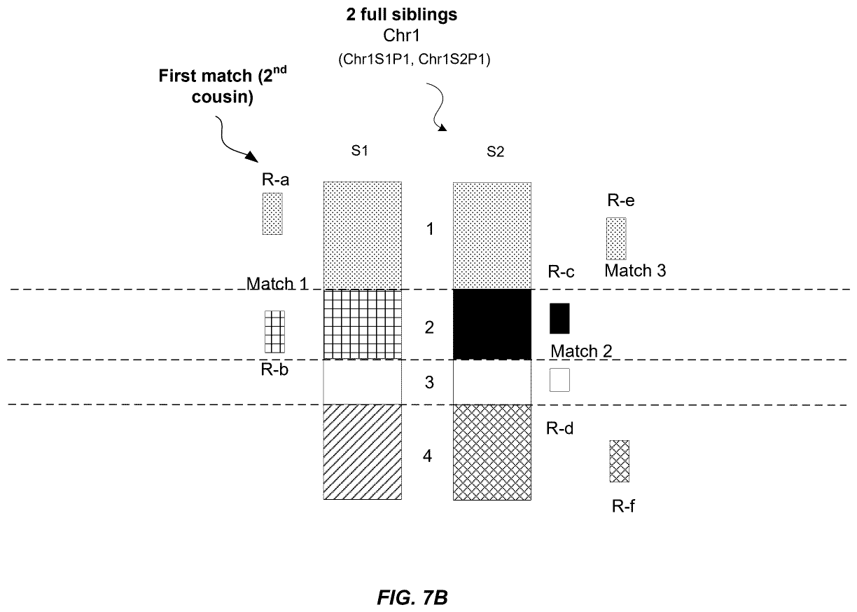

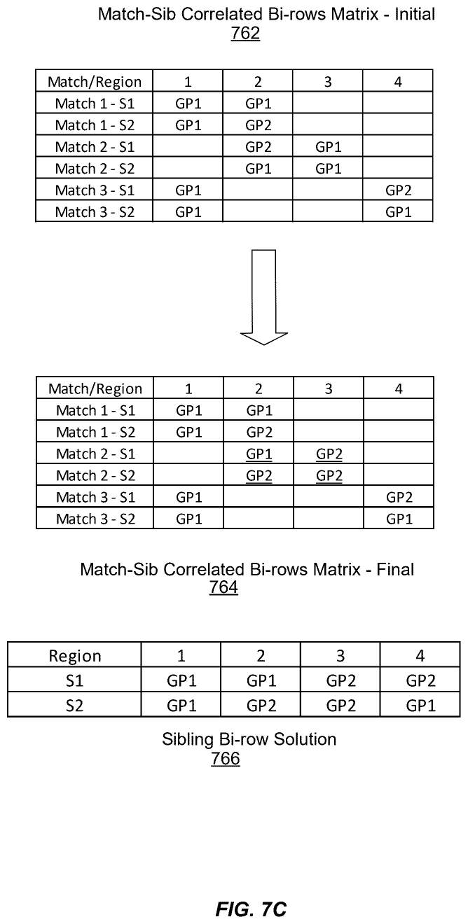

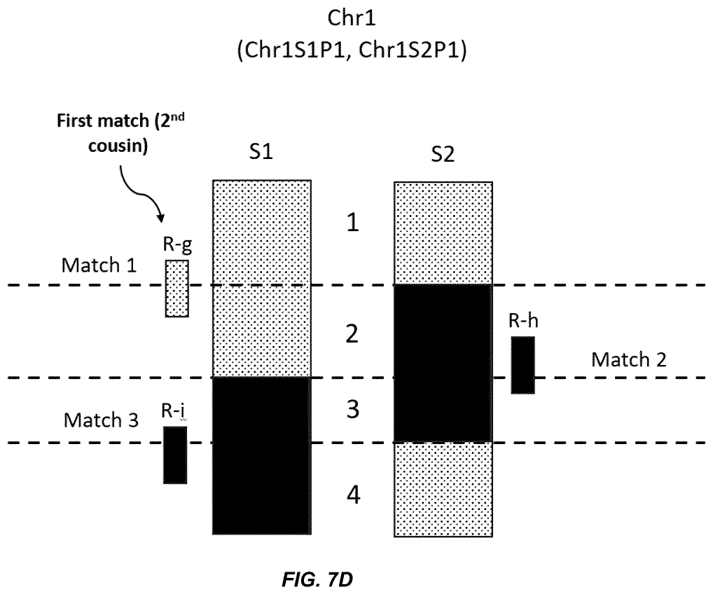

The parental reconstruction engine 270 reconstructs a parental genome using the children's genotype data. In some embodiments, the parental reconstruction engine 270 may compare the chromosome copies of the plurality of siblings to identify, for each sibling, which of the haplotypes was inherited from a same parent. The parental reconstruction engine 270 may identify recombination breakpoints in the sibling haplotypes and reconstruct a pair of parental haplotypes based on the identified recombination points. The reconstruction engine may reconstruct an unphased parental genome, a phased parental genome, or both. In some embodiments, the parental reconstruction engine 270 may also reconstruct a parental genome using two children's data. For example, the parental reconstruction engine 270 may use a phasing matrix approach that is described in FIG. 7A through 7D to reconstruct the parental genome.

In this disclosure, genetic data may be an example of inheritance data. An individual is an example of a named entity. A genetic sequence is an example of a data string or a bit string. A genetic dataset is an example of a data instance. A genetic segment is an example of data string segment. A matched genetic segment is an example of a matched data string. For example, an IBD segment is an example of a matched data string segment. A haplotype is an example of a phased data string. An ethnicity is an example of a data origin or a data classification. A phenotype is an example of a data manifestation. A reproductive event is an example of a data inheritance event.

In some embodiments, the disclosure is related to reconstructing a parent or an ancestral genetic dataset from the children genetic dataset. An ancestor may be a grandparent, great-grandparent, etc. A parent genetic dataset or an ancestral genetic dataset is an example of a precursory inheritance dataset or precursory data instance. A parent or an ancestor is an example of a precursor. A grandparent is an example of an ultra-precursor. A parental haplotype is an example of a phased precursory inheritance dataset. A child genetic data is an example of a successive inheritance dataset or successive data instance. A child is an example of a successor. A sibling genetic dataset is an example of a cognate dataset, a cognate data instance, or an associated data instance. A sibling is an example of a cognate. A recombination event may be an example of a data exchange event. A recombination breakpoint is an example of a data exchange breakpoint. A chromosome is an example of a data storage location.

### Reconstructing a Parent's Genome

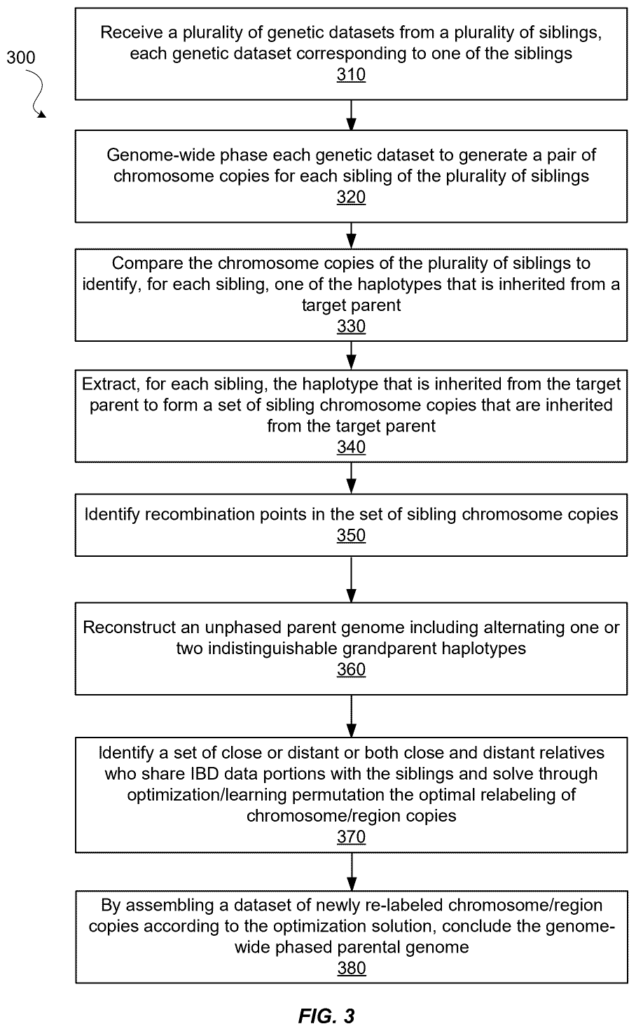

FIG. 3 is a flowchart depicting an example process 300 for reconstructing a precursory data instance using successive data instances, in accordance with some embodiments. The process 300 may be applied in various data processing fields. For example, in some embodiments, a parent's genome may be reconstructed from children's genotype data, in accordance with some embodiments. While the construction of a parent or an ancestor's genome using children's genotype data is used as the primary example in this disclosure, the process 300 and other features discussed in this disclosure may be applied to other data processing fields.

The process 300 may be performed by one or more engines of the computing server 130 illustrated in FIG. 2, such as the parental reconstruction engine 270. The process 300 may be embodied as a software algorithm that may be stored as computer instructions that are executable by one or more processors. The instructions, when executed by the processors, cause the processors to perform various steps in the process 300. In various embodiments, the process may include additional, fewer, or different steps. While various steps in process 300 may be performed with the use of computing server 130, each step may be performed by a different computing device.

In some embodiments, process 300 can include receiving 310 a plurality of data instances from a plurality of cognates. For example, the computing server 130 may receive a plurality of genetic datasets from a plurality of siblings. In some embodiments, the plurality of siblings may include two or more siblings. For the purpose of illustration, three siblings, S1, S2, and S3, are used. The plurality of siblings may share the same pair of parents. In this example, the siblings inherit their genetic data from the same two parents, e.g., paternal genetic data and maternal genetic data. Each of the plurality of genetic datasets corresponds to one of the siblings and contains data on the whole or portions of the sibling's genome. In some embodiments, the genetic dataset may be in the form of diploid data that includes a sequencing of genotypes, for example, a pair of alleles present on two copies of a chromosome for a sibling. The genetic datasets may be any suitable datasets stored in genetic data store 205.

Continuing with reference to FIG. 3, in some embodiments, process 300 can include phasing 320 each data instance to generate a pair of phased inheritance datasets for each cognate. For example, the computing server 130 may phase a genetic dataset to generate a pair of haplotypes for each sibling of the plurality of siblings. In some embodiments, the computing server 130 may genome-wide phase each genetic dataset to generate a pair of chromosome copies for each sibling of the plurality of siblings. The computing server 130 may use any suitable phasing algorithms of the phasing engine 220 to perform the phasing which may include genome-wide phasing. For example, an IBD-phasing algorithm of the phasing engine 220 may generate a phasing result that has a long genomic distance accuracy and cross-chromosome accuracy in terms of haplotype separation and correlation. For each sibling, a pair of chromosome copies may correspond to a diploid dataset that may be phased into one pair of haploid data, i.e., two sets of haploid data. One set of haploid data corresponds to the genetic dataset from a first parent and the other set of haploid data corresponds to the genetic dataset from the second parent. In some embodiments, at the stage of the phasing result, the computing server 130 may separate the haploid data of the first parent from those of the second parent. However, the computing server 130 may not know which parent is paternal or maternal.

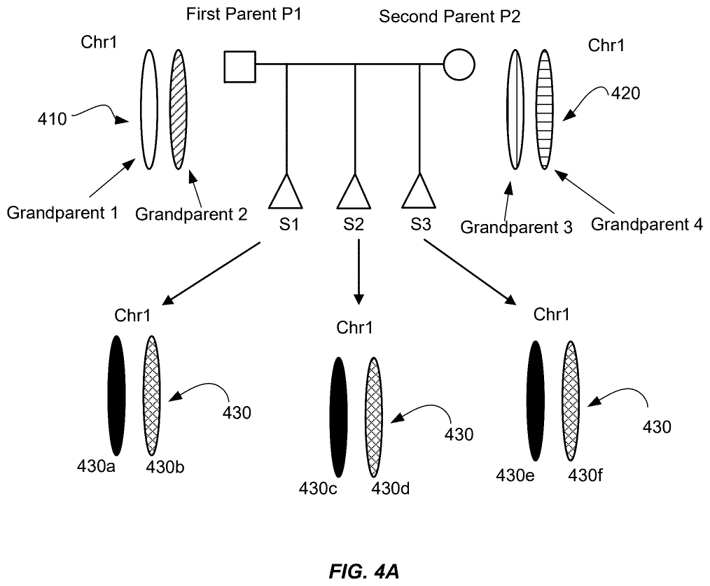

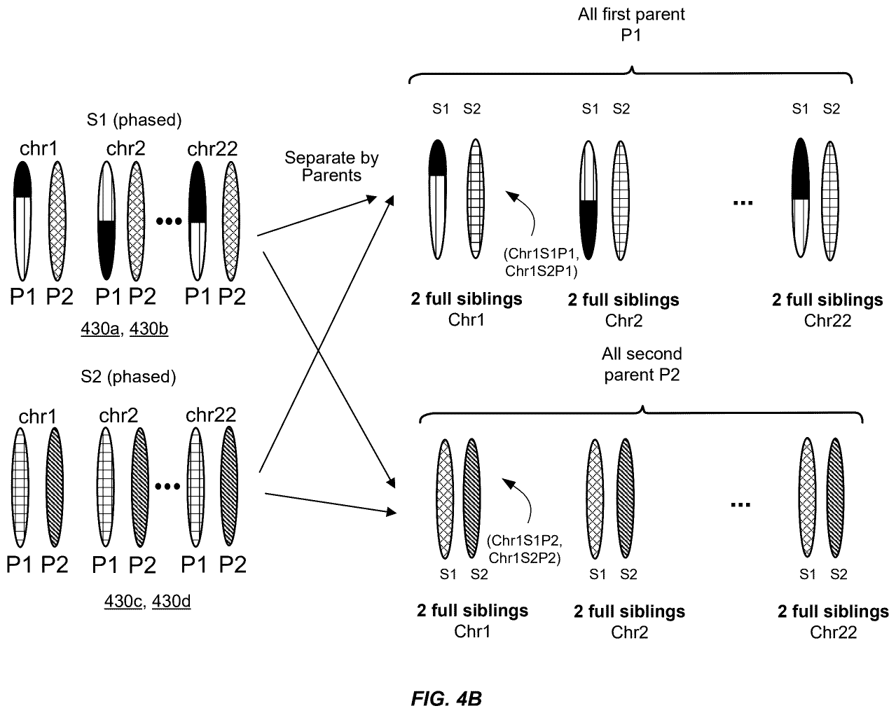

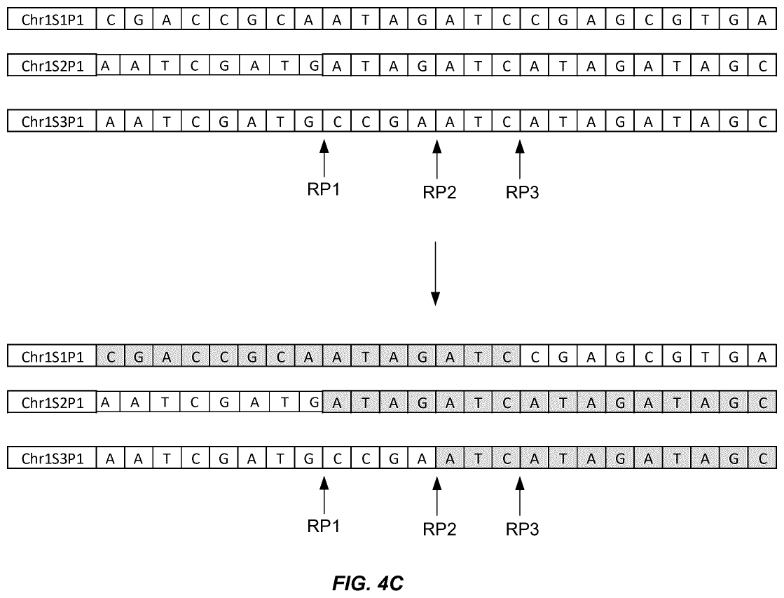

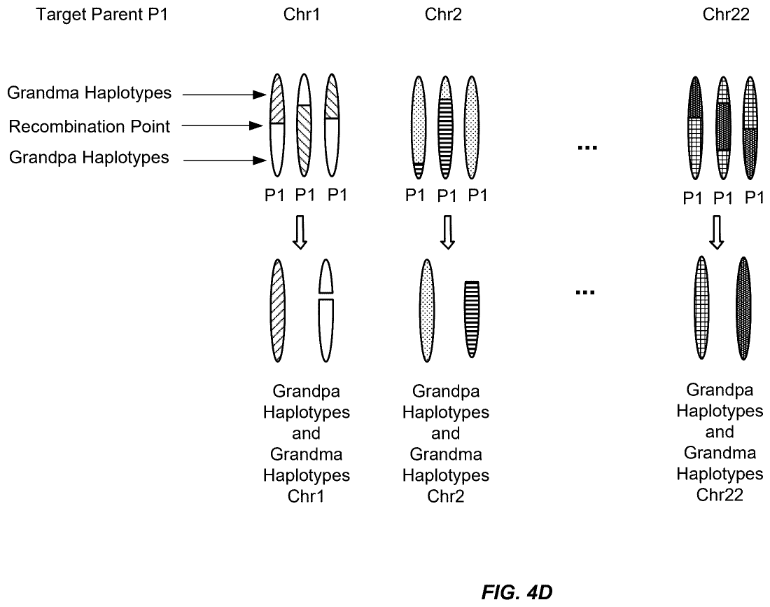

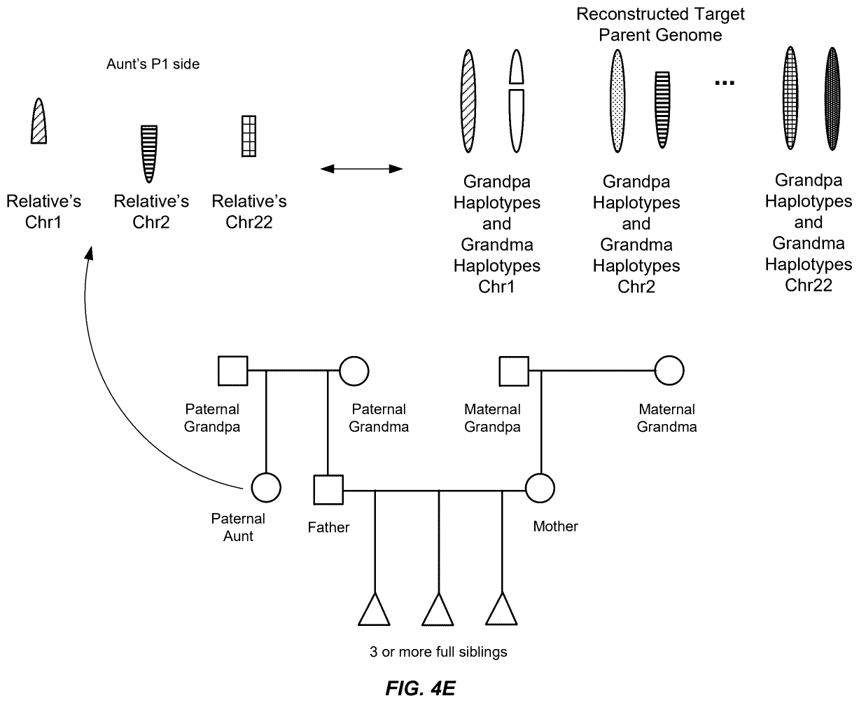

By way of example, FIG. 4A is a conceptual diagram illustrating some of the basic terms and concepts that are used in the process 300, in accordance with some embodiments. Taking a pair of chromosome copies, for chromosome 1 (Chr1), as an example, one parent of the three siblings (S1, S2, and S3) has a first set of diploid data 410, the other parent of the three siblings (S1, S2, and S3) has a second set of diploid data 420, and each one of the siblings (S1, S2, and S3) inherits a genetic dataset from both parents whereby each sibling has a third set of diploid data 430 that is most often unique for Chr1 (430a-f depicts that each child has one chromosome copy that is maternally inherited and one copy that is paternally inherited, but 430a-f is not attempting to show a level of detail that shows how and in what ways the dataset inheritance of each sibling is unique). For the first set of diploid data 410, a first haplotype (first chromosome) is inherited from the genetic dataset of the first parent's parent, i.e., a first grandparent (Grandparent 1) and the other set of haplotype data is inherited from the genetic dataset of the first parent's other parent, i.e., a second grandparent (Grandparent 2). Similarly, for the second set of diploid data 420, one set of haplotype data is inherited from the genetic data of the second parent's parent, i.e., a third grandparent (Grandparent 3) and the other set of haplotype data is inhered from the genetic data of the second parent's other parent, i.e., the fourth grandparent (Grandparent 4).

Here, it should be noted that “paternal” and “maternal” are sometimes used to differentiate the two parents of the siblings for clarity of description but the actual gender of the parents may not be known by the computing server 130 based on reviewing the genetic dataset of the siblings. Similarly, “grandfather” or “grandpa” and “grandmother” or “grandma” may sometimes be used to differentiate the grandparents for clarity of description but the precise gender of the grandparent may not be known by reviewing the haplotype data. Each parent's pair of haplotypes are recombined and passed to the child (S1, S2, or S3) to form the child's corresponding haplotypes. For example, the pair of haplotypes that correspond to the first set of diploid data 410, with each chromosome from one of the grandparents 1 and 2, are recombined and passed to one of the siblings (S3) to form one set of haploid data 430e that corresponds to the diploid dataset 430. Likewise, the pair of haplotypes that correspond to the second diploid dataset 420, with each chromosome from one of the grandparents 3 and 4, are recombined and passed to the sibling S3 to form the other set of haploid data 430f that corresponds to the diploid dataset 430. The other two siblings have diploid datasets similar to the diploid datasets 430e and 430f. The diploid datasets of the two other siblings are also inherited from the two parents but most often have different recombination points compared to the diploid datasets 430e and 430f.

In some embodiments, while the first set of diploid data 410 and the second set of diploid data 420 are illustrated in FIG. 4A, the computing server 130 may not have the first set of diploid data 410 or the second set of diploid data 420 because neither parent may be users or DNA testers with data available to the computing server 130. The process 300 may reconstruct the genetic data of one or both parents using the diploid datasets 430e and 430f of sibling S3 and the diploid datasets of the two other siblings. The three siblings may be users or DNA testers with data available to the computing server 130 so that the computing server 130 may have the genetic datasets of all three siblings stored in the genetic data store 205.

A subset of the SNPs in a sibling's genome may be detected with SNP genotyping via microarray assessment, through DNA sequencing, or through other available methods for SNP assaying. In DNA sequencing, a laboratory assay or a massively parallel sequencing process may start with a primer that is bindable to sequences from both chromosome copies, but are not able to correlate the DNA sequence with chromosome copies inherited from the same parent. The inability to correlate chromosome copies with the two alleles of an identified SNP is also a limiting factor of SNP genotyping via microarray assessment. As a result, SNP genotyping often identifies a pair of alleles for a given position in the genome, but may not identify which allele corresponds to which haplotype, i.e., SNP genotyping does not identify the homomorphic chromosome (of the homomorphic pair) to which each allele corresponds. Thus, SNP genotyping produces an unordered or only locally ordered pair of alleles, where each allele corresponds to one of two haplotypes. As such, the computing server 130 may receive the genetic dataset of the three siblings but the genetic data may be unphased or may only be phased at a very small (local) level.

The diploid dataset 430 of the sibling S3 may be genome-wide (or long-range/cross-chromosomal) phased to generate a pair of haplotypes 430e and 430f, which were inherited from the parents' diploid data 410 and 420 respectively, although at this stage, it is not determined which set of haploid data 430e or 430f is from which diploid dataset 410 or 420.

Using the phasing engine 220, the computing server 130 may perform the long-range phasing process for each genetic dataset for each sibling. In one example, for Chr1, the computing server 130 may long-range phase the diploid dataset of each sibling to generate a pair of haplotypes that are correlated across all chromosome copies for each sibling. For example, for three siblings S1, S2, and S3, the corresponding haplotypes for Chr1 may be 430a and 430b for S1, 430c and 430d for S2, and 430e and 430f for S3. Similarly, the computing server 130 may phase the diploid dataset for other pairs of chromosomes. In one example, the computing server 130 may generate 22 pairs of haplotype datasets, each pair of a haplotype dataset corresponding to one pair of chromosome copies. In embodiments in which long-range phasing is performed, the haplotype datasets may be chromosome copies. For three siblings S1, S2 and S3, the computing server 130 may generate 22x3 pairs of haplotype datasets. In some embodiments the computing server 130 may generate 23x3, 24x3, 25x3, or Nx3 (where N represents any number) pairs of haplotype datasets. Additionally, while pairs of haplotype datasets have been described, the approach is not limited to diploid organisms but rather may extend to any suitable ploidy, such as triploid, tetraploid, pentaploid, hexaploid, etc. Further, while long-range phasing is described, it will be appreciated that the disclosure is not limited thereto.

Continuing with reference to FIG. 3, in some embodiments, process 300 can include comparing 330 the phased inheritance dataset of the plurality of cognates to identify, for each cognate, one of the phased inheritance datasets that is inherited from a target precursor. For example, the computing server 130 may compare the chromosome copies of the plurality of siblings to identify one of the chromosome copies that is inherited from a target parent for each sibling. For each sibling, each chromosome may correspond to a haplotype or part of a haplotype generated by a long-distance phasing algorithm. In one example, for three siblings S1, S2, and S3, the haplotypes correspond to six sets of haplotype data, 430a, 430b, 430c, 430d, 430e, and 430f. To determine which three of the six sets of haplotype data are inherited from a same parent, the computing server 130 may compare the six sets of haplotype data to determine the highest correlation among the six sets of haplotype data. In some embodiments, the computing server 130 may identify matched portions of haplotype data between two siblings, e.g., comparing and identifying identical alleles at SNP sites in the phased haplotypes between two siblings. The computing server 130 may determine three sets of haplotype data, one from each sibling, that are correlated and inherited from a same parent. Since the haplotypes are from siblings who inherit the haplotypes from the same parents, three of the six haplotypes typically share long stretches of identical nucleotide sequences. Similarly, the other three of the six haplotypes also share long stretches of identical nucleotide sequences. As such, the six haplotypes are separated into two groups.

Continuing with reference to FIG. 3, in some embodiments, process 300 can include extracting 340, for each cognate, the phased dataset that is inherited from the target precursor to form a set of cognate phased datasets that are inherited from the target precursor. For example, the computing server 130 may extract for each sibling, the chromosome copy that is inherited from the target parent to form a set of sibling chromosome copies that are inherited from a target parent for each sibling. The target parent may be the first parent P1 or the second parent P2. At this stage, whether these three sets of haplotype data are from the paternal or maternal parent is typically not determined, although such determination can be optional in some embodiments. The computing server 130 may re-label the three sets of haplotype data as Chr1S1P1, Chr1S2P1, and Chr1S3P1, indicating that the three sets of haplotype data are correlated to a same parent P1 (father or mother), and each corresponds to a sibling. The second group of three sets of haplotype data may be labelled as Chr1S1P2, Chr1S2P2, and Chr1S3P2.

FIG. 4B is a conceptual diagram graphically illustrating the haplotypes of the siblings that are inherited from a same parent, in accordance with some embodiments. While FIG. 4B shows the haplotypes or chromosome copies from two siblings being sorted according to P1 and P2, it will be appreciated that the depiction is merely exemplary, and the haplotypes of any suitable number of siblings, such as three or more, may be similarly sorted. The computing server 130 compares the haplotypes of the three siblings S1, S2, and S3 for each pair of chromosome copies, and identifies one of the haplotypes that is inherited from a same parent for each sibling. As shown in FIG. 4B, for each chromosome, from Chr1 to Chr22, the haplotypes of the siblings are correlated based on the parent from whom the haplotypes are inherited. The haplotypes are re-labeled accordingly. For example, Chr1S1P1 indicates the set of haplotypes of the sibling S1, associated with Chr1, and inherited from the parent P1. Although which parent P1 or P2 is the paternal parent or maternal parent is not determined at this stage, the computing server 130 may extract the haplotype that is inherited from a same parent to form a set of sibling haplotypes. For example, the sets of haplotypes, Chr1S1P1, Chr1S2P1, Chr1S3P1, are determined to be inherited from a same parent P1, and form a set of sibling haplotype data inherited from the parent P1. Similarly, the sets of haplotypes, Chr1S1P2, Chr1S2P2, Chr1S3P2, are determined to be inherited from a same parent P2, and form a set of sibling haplotype data inherited from P2. In some embodiments, the computing server 130 may extract, for each sibling, the haplotype that is inherited from a same parent for each of 22 chromosomes and form a full set of sibling haplotype datasets that were inherited from the same parent, i.e., P1 or P2. As shown in FIG. 4B, for sibling 1 (S1), the black shaded haplotypes are inherited from the same parent P1, and the haplotypes illustrated in patterns are inherited from the same parent P2. As mentioned previously, the haplotypes may be sorted into parents based on a degree of matching between alleles observed in the haplotypes, based on matches associated with the haplotypes during phasing, or by any other suitable modality.

Continuing with reference to FIG. 3, in some embodiments, process 300 can include identifying 350 data exchange breakpoints in the set of cognate phased datasets, wherein identifying the data exchange breakpoints comprises identifying locations of change in data agreement among the cognate phased datasets. For example, the computing server 130 may identify recombination breakpoints in the set of sibling chromosome copies. A recombination breakpoint may refer to a location at which a change in agreement of haplotypes occurs among the set of sibling haplotypes. As each parent's pair of haplotypes are often recombined and passed uniquely to each child (S1, S2, S3) to form the child's corresponding haplotypes, the extracted haplotypes from the siblings, although inherited from the same parent, may not be identical to the haplotypes of the parent nor to each other. For example, for a parent's pair of haplotypes, one set of haplotype data is from one grandparent (e.g., grandfather haplotypes) and the other set of haplotype data is from the other grandparent (e.g., grandmother haplotypes). The grandfather haplotypes and the grandmother haplotypes break and recombine to pass to the child, e.g., S3, to form one set of the child's haplotypes that is inherited from the parent. The recombined haplotypes for each of the siblings (S1, S2, and S3) may therefore be different. The recombined haplotypes of the siblings may have different portions of the grandfather and grandmother haplotypes and the different portions may be recombined at different points in the haplotypes. Therefore, in some embodiments, to reconstruct a parent's haplotypes, i.e., the grandfather and grandmother haplotypes, the computing server 130 may identify the recombination breakpoints in each of the siblings' haplotypes.

FIG. 4C shows an example portion of a set of sibling haplotypes, in accordance with some embodiments. As shown in FIG. 4C, the set of sibling haplotypes, ChrISIP1, Chr1S2P1, Chr1S3P1, are inherited from a same parent P1, e.g., the paternal or maternal parent. In one example, each of the haplotypes includes a portion of grandfather haplotypes and a portion of grandmother haplotypes. The two portions are recombined at a plurality of recombination breakpoints which each may also be denoted as a recombination point RP. For each sibling's haplotypes, the two portions may be different and recombined at a different recombination point. In some embodiments, each of the haplotypes may include one or more portions of grandfather haplotypes and/or one or more portions of grandmother haplotypes, and the portions of the grandfather and grandmother haplotypes may be combined at one or more recombination points, e.g. RP1, RP2, RP3, in the sibling's haplotypes. In one example, a sibling's haplotypes may include one recombination point at which a portion of grandfather haplotypes and a portion of grandmother haplotypes are recombined. In another example, the sibling's haplotypes may include a plurality of recombination points at which different portions of grandfather haplotypes and portions of grandmother haplotypes are recombined. In another example, the sibling haplotypes may have zero recombination points RP, and the sibling's haplotypes may be identical to a parent's haplotypes, i.e., the sibling haplotypes are identical to the grandfather haplotypes or the grandmother haplotypes.

The computing server 130 may, for example, identify that sibling 1's and sibling 2's haplotypes are different until a particular location, after which point they are the same; this can be identified, using a voting-process approach described below, at RP1. The computing server 130 may compare the sequence of alleles for the set of sibling haplotypes after RP1 and identify a second recombination point RP2. Between the first recombination point RP1 and the second recombination point RP2, Chr1S1P1 and Chr1S2P1 share the same segment and Chr1S3P1's segment is different. In some embodiments, the computing server 130 may determine the recombination points based on a voting process. The probability of two or more haplotypes having a recombination point at the same location is less than the probability of only one haplotype having a recombination point at the location. In some embodiments, at the recombination point, the computing server 130 may determine that a majority of the haplotypes, such as sibling haplotypes, resulting from the voting process did not have the recombination, and a minority of the sibling haplotypes resulting from the voting process did have the recombination where the corresponding haplotypes changed from being associated with one grandparent's haplotype to another grandparent's haplotype. Here, it is less likely that the haplotypes of two siblings recombine at the same location than the haplotype inherited by one sibling had recombined at the location. For example, it is more likely that Chr1S2P1 has a recombination point at RP1 and less likely that both Chr1S1P1 and Chr1S3P1 have a recombination point at RP1. The computing server 130 may determine that between RP1 and RP2, Chr1S2P1 changes from the grandfather haplotypes to grandmother haplotypes, Chr1SIP1 continues with the grandmother haplotypes, and Chr1S3P1 continues with the grandfather haplotypes.

Similarly, the computing server 130 continues comparing the sequence of alleles for the set of sibling haplotypes after RP2 and identifies a third recombination point RP3. Between the second recombination point RP2 and the third recombination point RP3, Chr1S1P1, Chr1S2P1, Chr1S3P1 all share the same segment. Again, it is less likely that the haplotypes of two siblings recombine at the same location than the haplotypes of one sibling recombine at a location. For example, the computing server 130 may determine that it is more likely that Chr1S3P1 has a recombination point at RP2 and less likely that both Chr1S1P1 and Chr1S2P1 have a recombination point at RP2. The computing server 130 may determine that between RP2 and RP3, Chr1S3P1 changes from the grandfather haplotypes to grandmother haplotypes, Chr1SIP1 and Chr1S2P1 continue with the grandmother haplotypes, thus, all three siblings' haplotypes are from the grandmother haplotypes.

The computing server 130 continues comparing the sequence of alleles for the set of sibling haplotypes after RP3 and identifies no additional recombination point within the portion shown in FIG. 4C. After the third recombination point RP3, Chr1S2P1 and Chr1S3P1 share the same segment and Chr1S1P1's segment is different. The computing server 130 may determine that it is more likely that Chr1S1P1 has a recombination point at RP3 and less likely that both Chr1S2P1 and Chr1S3P1 have a recombination point at RP3. The computing server 130 may determine that after RP3, Chr1SIP1 changes from the grandmother haplotypes to grandfather haplotypes, Chr1S2P1 and Chr1S3P1 continue with the grandmother haplotypes.

As illustrated in FIG. 4C, the computing server 130 may determine from the haplotypes of sibling S1, Chr1S1P1, that S1 has a recombination point at RP3, changing from grandmother haplotypes to grandfather haplotypes; from the haplotypes of sibling S2, Chr1S2P1, that S2 has a recombination point at RP1, changing from grandfather haplotypes to grandmother haplotypes; and from the haplotypes of sibling S3, Chr1S3P1, that S3 has a recombination point at RP2, changing from grandfather haplotypes to grandmother haplotypes.

Continuing with reference to FIG. 3, in some embodiments, process 300 can include reconstructing 360 a pair of precursory phased inheritance datasets based on the identified data exchange breakpoints. In some embodiments, the computing server 130 may reconstruct an unphased parent genome which may also be called a locally phased or chromosome-level phased parent genome that comprises alternating one or two possibly indistinguishable grandparent haplotypes. In embodiments, the grandparent haplotypes may be identified for the entire length of a chromosome, but correlation across chromosomes may not be determined. For example, the computing server 130 may reconstruct a pair of parental haplotypes based on the identified recombination points. In some embodiments, the computing server 130 may identify portions of haplotypes based on the identified recombination points, e.g. a portion being that segment of a haplotype that falls between two adjacent recombination points, and assign each identified portion of haplotypes to be associated with one parent of the target parent, i.e., a grandparent haplotype. In some embodiments, the computing server 130 may assign the grandparent haplotypes based on a voting process. Here, it should be noted that “grandfather” and “grandmother” are used to differentiate the two parents of P1 for clarity of description and are not used to designate the paternal or maternal parent of P1. Similarly, the computing server 130 may assign a first portion of Chr1S2P1 before the recombination point RP1 as being from the grandfather haplotypes and a second portion of Chr1S2P1 after the recombination point RP1 as being from the grandmother haplotypes. The computing server 130 may assign a first portion of Chr1S3P1 before the recombination point RP2 as being from the grandfather haplotypes and a second portion of Chr1S3P1 after the recombination point RP2 as being from the grandmother haplotypes. In some embodiments, some of the sibling haplotypes may include a plurality of recombination points, and the computing server 130 may identify the corresponding portions of haplotypes and assign each portion of haplotypes to be associated with one parent of the target parent, i.e., a grandparent.

The computing server 130 may rearrange the grouped portions of haplotypes related to one grandparent to construct the haplotypes related to the grandparent. For example, the computing server 130 may group a first portion of Chr1S1P1 before the recombination point RP3, a second portion of Chr1S2P1 after the recombination point RP1, and a second portion of Chr1S3P1 after the recombination point RP2 in a group for reconstructing the grandmother haplotypes. In some embodiments, the computing server 130 may rearrange the portions of haplotypes based on the sequence of alleles at the SNP sites.

FIG. 4D is a conceptual diagram illustrating the process of reconstructing haplotypes of the target parent, in accordance with some embodiments. The computing server 130 may identify the recombination points in the set of sibling haplotypes for each chromosome, e.g., from Chr1 to Chr22, as shown in FIG. 4D. In some embodiments, the plurality of siblings may include more than three siblings, and the computing server 130 may compare the extracted haplotypes for each sibling to identify recombination points in the haplotypes that are inherited from the same parent for each chromosome. Note that in some embodiments, because of the recombination and natural genetic-inheritance process, all three siblings, at a genomic locus, may happen to inherit the same chromosome from the same grandparent. For example, in Chr2 P1 illustrated in FIG. 4D, all three siblings inherit the chromosome segment from the grandfather at the top portion of the Chr2 P1. As a result, the grandmother's haplotype sequence at that the top portion is undetermined. Again, grandfather and grandmother here are merely used to signify there are two grandparents. As described herein, a percentage or proportion of a parental genome that can be reconstructed may depend on how many such regions exist, where the siblings inherited the same grandparental haplotype such that the other, non-inherited grandparental haplotype is now lost and not recoverable without additional siblings or other relatives.

In some embodiments, the reconstruction may be limited locally within a chromosome. Yet, in some embodiments, the reconstruction may be a genome-wide reconstruction of the target parent genome or a measurable portion of the target parent genome occurring across multiple or all chromosomes. Here, as illustrated, from Chr1 to Chr 22, the computing server 130 is able to recover a majority of the target parent's genome. In some embodiments, the genome here refers to at least 1% of the entire human genome. In some embodiments, the genome here refers to at least 5% of the entire human genome. In some embodiments, the genome here refers to at least 10% of the entire human genome. In some embodiments, the genome here refers to at least 20% of the entire human genome. In some embodiments, the genome here refers to at least 30% of the entire human genome. In some embodiments, the genome here refers to at least 40% of the entire human genome. In some embodiments, the genome here refers to at least 50% of the entire human genome. In some embodiments, the genome here refers to at least 60% of the entire human genome. In some embodiments, the genome here refers to at least 70% of the entire human genome. In some embodiments, the genome here refers to at least 80% of the entire human genome. In some embodiments, the genome here refers to at least 90% of the entire human genome. In some embodiments, the genome here refers to at least 95% of the entire human genome. In some embodiments, the genome here refers to at least 99% of the entire human genome. In some embodiments, the genome here refers to 100% of the entire human genome.

Note that at this stage illustrated by FIG. 4D, the phasing of the target parent's genetic data is known within a chromosome but not across chromosomes. For example, within the two reconstructed copies of Chr1, the phasing of two haplotypes of the target parent is shown as a dash-line-filled pattern and a white filling. However, the phasing is undetermined across chromosome pairs. For example, which reconstructed copy of Chr1 and which reconstructed copy of Chr2 are inherited from the same grandparent is unknown unless additional steps are performed. The left haplotype shown for Chr1 may share the same grandparent as the left haplotype or the right haplotype shown for Chr2. In some embodiments, the computing server 130 may use the phasing engine 220 to perform phasing of the target parent's haplotypes across chromosomes.

The computing server 130 reconstructs the grandmother haplotypes using the phased haplotypes that are determined to be inherited from the same grandparent, e.g., grandmother. Similarly, the computing server 130 may reconstruct the grandfather haplotypes using the phased haplotypes that are determined to be inherited from the same grandparent, e.g., grandfather. In this way, the computing server 130 reconstructs both chromosome copies (i.e., grandfather haplotypes and grandmother haplotypes) for the target parent P1 using the set of sibling haplotypes. The computing server 130 reconstructs both parental chromosome copies based on the rearranged sibling haplotypes. A similar process may be used to reconstruct both chromosome copies for the other parent P2 of the siblings. At this stage, an unphased (or locally phased or chromosome-level phased) reconstructed genome of each parent has been obtained.

### Using Close Relatives Genomes for Correlating a Parent's Haplotypes

Additionally, or alternatively, in some embodiments, the computing server 130 may phase haplotypes that are inherited from the same grandparent, e.g., grandfather haplotypes or grandmother haplotypes, using other approaches. In some embodiments, the computing server 130 may use one or more relatives' haplotypes to determine cross-chromosome phasing. In some embodiments, the computing server 130 may also use one or more relatives' haplotypes shared with the siblings to determine whether the target parent is a paternal parent or a maternal parent, i.e., whether the target parent is the siblings' father or mother. The relatives here may be closer relatives such as someone who is present in the target parent's family tree managed by a tree management engine 260. In some embodiments, relatives may also mean genetic matches such as IBD matches that are determined by the IBD estimation engine 225.

In some embodiments, the computing server 130 may identify 370 a set of close, distant, or both close and distant relatives who share IBD data portions with the siblings and solve through optimization/learning permutation the optimal relabeling of chromosome/region copies. FIG. 4E is a conceptual diagram graphically illustrating using a close relative's haplotypes to determine phasing of haplotypes of the target parent across chromosomes, in accordance with some embodiments. Individuals who are closely related share a relatively large number of segments of haplotypes, and individuals who are more distantly related share relatively fewer segments. Individuals who are closely related to the target parent may share IBD data between both of their own chromosome copies and with both copies of the reconstructed target parent genome. In some embodiments, only one or multiple close relatives may be available. In some embodiments, such as for siblings who do not have many close relatives in the genetic data store 205 because they are relatively new customers of the genetic/genealogy research service, only distant relatives may be available (e.g. second cousin or further). Individuals who are distantly related to the target parent may share IBD data between only a single one of their own chromosome copies and with only a single copy of the reconstructed target parent genome. In some embodiments, only one or multiple distant relatives may be available. In some embodiments, a mixture of close and distant relatives may be available. In some embodiments, if the genome-wide phased genetic data of a closer relative (e.g., aunt or uncle, etc.) is available in the genetic data store 205 or is determined through the phasing engine 220, the phased haplotypes of the relative may be directly compared with the reconstructed target parent genome to determine the cross-chromosome phasing, providing the information necessary to resolve a fully reconstructed genome-wide phased parental genome. For example, as conceptually illustrated in FIG. 4E, by comparing the reconstructed target parent genome to the aunt's phased haplotypes from a single grandparent side (i.e. haplotypes that are identified through genome-wide phasing to belong to the aunt's own labeled P1 only or P2 only side) matching the reconstructed target parent genome, the computing server 130 is able to determine that the left haplotype in Chr1, the right haplotype in Chr2, and the left haplotype in Chr22 belong to the same grandparent. As such, cross-chromosome phasing is determined, and through re-labeling, the entire phased genome has been reconstructed.

In some embodiments, a relative's genetic data may also be used to determine whether a haplotype of the target parent is paternal or maternal. A paternal relative shares more haplotype segments with the father of the siblings and fewer haplotype segments with the mother of the siblings. For a relative with a known paternal/maternal relationship, e.g. maternal uncle, the computing server 130 may compare the relative's haplotypes with the pair of parental haplotypes for the parents P1 and P2 respectively. Responsive to determining that P1's haplotypes have more shared segments with the relative than the P2's haplotypes, the computing server 130 may determine that P1 is from the corresponding relative's side. For example, the relative may be a paternal aunt, i.e., the father's sister. The computing server 130 compares the haplotypes of the paternal aunt with the pair of parental haplotypes for the parents P1 and P2, respectively. The computing server 130 may determine that P1's haplotypes have more shared segments than P2, and therefore determine that P1 is the father and P2 is the mother of the siblings.

In practice, in some embodiments, the determination of cross-chromosome phasing of the reconstructed target parent genome is much more complex than the conceptual illustration in FIG. 4E for various reasons. For example, the computing server 130 may not have the genetic data of a close relative or does not know the close relative is in fact a close relative. The genetic data of the close relative may not match the reconstructed target parent genome as perfectly as illustrated. In some situations, the computing server 130 may identify a plurality of IBD matches but may not have a close relative. In some situations there may be only a small number of distant relatives. In some situations there may be a large number of distant relatives, each sharing only a small number of IBD matches. In some embodiments, one or more closer relatives' genetic data are available, but none of the genetic data are sufficient to determine the phasing alone. In some embodiments, due to imperfect phasing, double relationships e.g. endogamy, and other situations, there may be a conflict in correlated phase labels across multiple close, distant, or both types of relatives. In some embodiments, a novel permutation optimization algorithm of a correlated information matrix is used to determine the genome-wide (cross-chromosome/region/long-range) phasing. In some embodiments, one or more machine learning models are trained to determine the cross-chromosome phasing. In some embodiments, the cross-chromosome phasing solution having the highest probability from the optimization algorithm is chosen as the final solution.

In some embodiments, the reconstruction process can include assembling the regions and/or chromosomes separated by the recombination breakpoints into distinctly labeled entities. This is particularly important when there is a paucity of close relatives to the parents available for determining the shared copy of each chromosome or region that belongs to a given parent. In practice with some embodiments, only more distant relatives (2^{nd} cousins (M6) or even much more distantly related) are available for identifying which regions or chromosome copies are correlated, and each of these may only have a sparse number of shared regions with the parent and siblings across the entire genome. In some embodiments there may be a mixture of close relatives to the parents and distant relatives to the parents. The computing server may assess the identified IBD regions of each match relative to the given parent for regions that substantially overlap (typically at least 100 contiguous SNPs) with any of the chromosomes or region entities identified to be separated by recombination breakpoints. A priori it may be unknown whether the IBD regions are from a relative to the P1 parent or to the P2 parent. Regardless, in some embodiments, the currently labeled P1 or P2 for each relative and region is assigned to an information matrix with consistently labeled P1 or P2 for each IBD region or chromosome of the given relative. The information matrix is completed for all desired relatives.

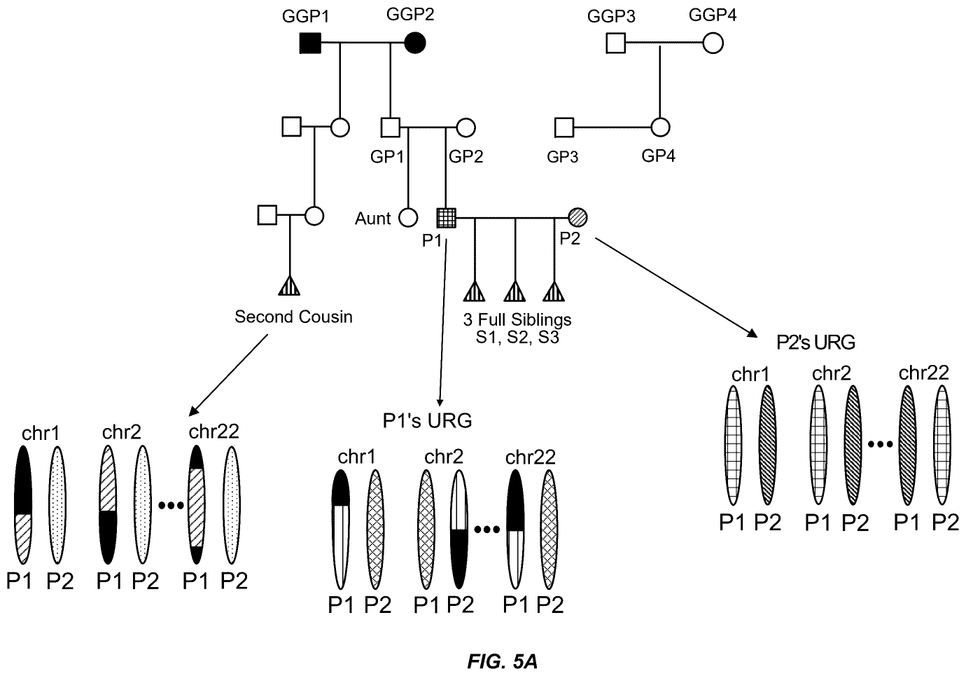

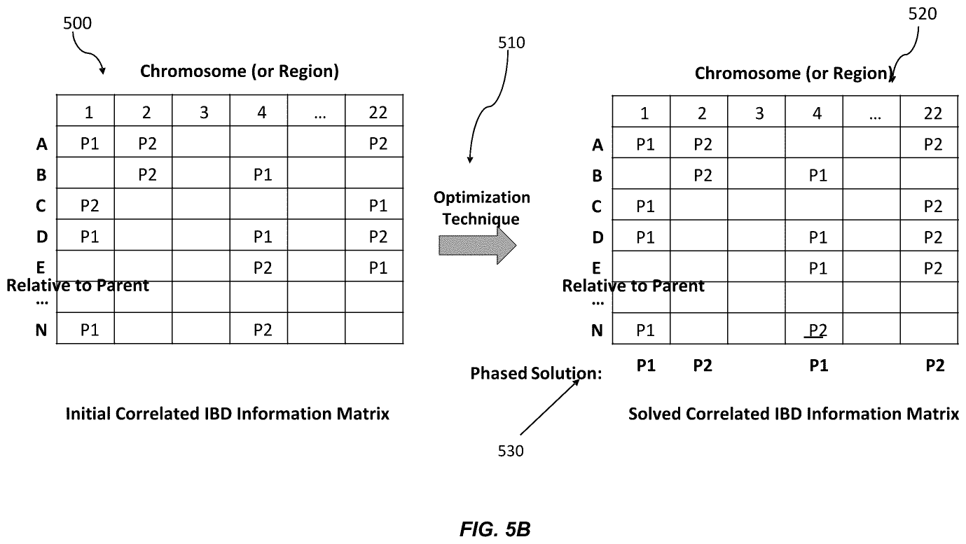

FIG. 5B shows an example information matrix, in accordance with some embodiments. The initial IBD correlation matrix 500 contains the P1 or P2 assignment that can be made for any given relative to the targeted parent, and this information is collated for all desired relatives. Without loss of generality, the correlation matrix 500 can be described, for one example, as consisting of a matrix having 22 chromosomal regions as columns and N relatives to the parent as rows. In practice the number of columns or rows can be in the hundreds or thousands. Each cell entry contains the current assignment of P1 or P2 or no information (blank) for a given relative. This constructed information matrix 500 may then be fed into an optimization algorithm 510 which minimizes the disagreement of P1, P2 labels in any given column across all columns. To one skilled in the art, it will be obvious that the minimization objective of this optimization algorithm can be weighted by a variety of measures including uniformity, density of SNPs, shared cM, estimated degree of relative closeness, total shared IBD regions, total IBD shared length, etc. The optimization algorithm identifies the optimal combination of permuted rows (a row permutation consists of switching all P1s to P2s and all P2s to P1s on a given row) which results in the minimization of the objective metric. The permutations that occur in meeting this objective are illustrated in the final IBD correlation information matrix 520. Of note, in some embodiments, there may be multiple minimization objectives that are possible and also in some embodiments, the global minimization objective may not be identified. In some embodiments, a perfect-agreement solution is not possible. This is illustrated in the final row of 520 where for relative N and chromosomal region 4, the final P2 label is likely to be incorrect based on the information from the other relatives and their correlations. However, this does not always deter the reaching of the correct parental label for that region which may be obtained by utilizing a majority vote for each region or chromosome in the final information matrix which may also be weighted. The optimization process is performed until conditions satisfying the reaching of a minimal objective are met, and the final solved solution is reflected in 530. As shown in FIG. 5B, not all regions or chromosomes may have a relative sharing IBD in that locus and with other loci that can be leveraged for optimization, such as for column 3. In such circumstances, these regions may be identified as not being able to have a genome-wide (or long-range) phased reconstruction or being phasable for reconstruction with lower confidence, whereas they may still contribute to the reconstruction of the unphased (or locally phased) genome.

In some embodiments, by assembling a dataset of newly re-labeled chromosome/region copies according to the optimization solution, the computing server may conclude 380 the genome-wide phased parental genome.

In some embodiments, the process 300 may be carried out iteratively for additional generations. For example, the computing server 130 may receive a plurality of sibling genetic datasets and a plurality of cousin genetic datasets. The sibling genetic datasets may be used to reconstruct part of the genome of a parent. The cousin genetic datasets corresponding to siblings of their own may be used to reconstruct genetic datasets of one or more uncles and/or aunts. The parent, uncles and aunts may also be siblings and part of the genome of a grandparent may be reconstructed using the process 300 by reapplying the process 300. The process 300 can iteratively be applied to reconstruct additional ancestors as long as sufficient data is available to the computing server 130.

### Using Distant Relatives' Genomes for Correlating a Parent's Haplotypes

FIG. 5A is a conceptual diagram graphically illustrating using a second cousin's haplotypes to correlate a target parent's haplotypes across chromosomes, in accordance with some embodiments. A second cousin is illustrative of distant relatives, i.e., those who are distant enough related to share the majority of their shared genetic sequence with only one grandparent of the siblings (i.e. in many situations all or a vast majority of a distant relative's IBD matches will be with only one chromosome copy of the parent). In some scenarios there may be only one or a few distant relatives. In some scenarios there may be many distant relatives. In some scenarios there may be a mixture of close and distant relatives. Based on the siblings' genome, the parents P1 and P2's haplotypes may be reconstructed. However, at this stage, P1 and P2's genome may be an unphased reconstructed genome (URG) or may be phased at a reconstructed chromosome level but not correlated across all chromosomes (or locally phased). In some implementations, one or more second cousin or further relatives' locally phased or genome-wide phased genomes may be used to determine correlations of a parent's haplotypes across the chromosomes. As shown in FIG. 5A, a target parent P1 has haplotypes that are inherited from a pair of grandparents, GP1 and GP2. The grandparent GP1 has haplotypes that are inherited from a pair of great grandparents, GGP1 and GGP2. The siblings have a second cousin from the parent P1's side, i.e., the siblings and the second cousin share at least one of the great grandparents GGP1 and/or GGP2 and, in turn, the siblings and the second cousin are very likely to share all or most of their IBDs through these great grandparents, as opposed to through great grandparents through GP2, GP3, or GP4. Similarly, the second cousin is very likely to share IBDs with the parent P1 and the grandparent GP1. In other words, the shared IBDs between the second cousin and the parent P1 indicates that P1's corresponding haplotype is inherited from the grandparent GP1 rather than the grandparent GP2, facilitating accurate assignment of portions of haplotypes shared between matches and siblings to the pertinent grandparent. In some embodiments, the shared IBDs for each chromosome can be identified based on one or more second cousin's genomes and/or one or more more-distant relatives' genomes. In this way, the haplotype of the parent P1 that is inherited from the grandparent GP1 may be identified for each chromosome, the identified haplotypes may be correlated to the same grandparent GP1 for all chromosomes, and the cross-chromosome correlations of the phased parent haplotypes may be determined. In other embodiments, a plurality of second cousins and/or other combinations of more distant relatives are utilized to identify shared IBDs across all or many of the chromosomes—similarly allowing for computation of cross-chromosome correlations and hence resolution of the genome-wide (long-range) phased parental genome. It should be noted that not all relatives share IBDs with only one of the parents or with only one of the grandparents. Hence, in other embodiments, such shared IBDs across both parental sides is determined and used as a filter in deciding the value of including a relative's IBDs in calculation of the cross-chromosome correlations. Due to this and other potential sources of error, in those embodiments with multiple numbers of relatives sharing IBDs, an optimization engine is utilized to determine an optimal solution of IBD sharing and cross-chromosome correlation—resulting in an optimal estimated reconstruction of the phased parent genome.

In one example, in FIG. 5A, portions of the genomes of the great grandparents GGP1 and GGP2 (shown in black color) are passed down to the offspring. The siblings and a second cousin may share IBD through their great grandparents GGP1 and/or GGP2. For example, a match sharing enough cM to be considered a likely second cousin (labeled as an “M6” match) may be found and predicted to be a second cousin to the three siblings. The shared IBD through the great grandparents GGP1 and/or GGP2 may be found on the same genome-wide phased genome for the matching second cousin for all chromosomes. Since the reconstructed genome for the other parent P2 is not related to the second cousin in this example, the computing server 130 may not identify any IBD with this second cousin's genome and the reconstructed haplotypes of the other parent P2, thereby allowing for more accurate calculation of the cross-chromosome correlation with the parent P1 haplotypes.

As conceptually illustrated in FIG. 5A, by comparing the reconstructed target parent P1's genome to the second cousin's haplotypes that match the reconstructed target parent genome, the computing server 130 is able to determine the left haplotype in Chr1, the right haplotype in Chr2, and the left haplotype in Chr22 were inherited from the same grandparent, i.e., from the grandparent GP1. As such, cross-chromosome correlation is determined. The computing server 130 may determine the remaining set of haplotypes of the target parent P1 to be inherited from the other grandparent GP2.

In some embodiments, the relative's haplotypes may be one or more portions of haplotypes. In some embodiments, the relative's haplotypes may include one or more portions of haplotypes for one or more chromosomes. In some implementations, the relative may be an individual that shares genetic material with both grandparents on the paternal or maternal side. In some implementations, the relative may be a close or distantly related individual that shares or appears to share genetic material with both the paternal and maternal parent of the target parent due to incorrect genome-wide phasing, the presence of identity by state segments, unknown relatedness on both parental sides, being a descendant of a close relative (such as a first cousin's offspring or niece/nephew or their offspring), or other reasons—and hence is not useful for this cross-chromosome phasing step. In some embodiments, more than one relatives' haplotypes may be used to identify whether a target parent is the paternal or maternal parent. The computing server 130 may use various ways to determine whether a target parent is a paternal or maternal parent. In some examples, the computing server 130 may access information such as a family tree, ethnicity, community assignment, and linkage to determine the paternal/maternal relationship of the target parent. In some embodiments, a plurality of relatives' haplotypes may be used to further construct the parental haplotypes for a grandparent. For example, based on the reconstructed pair of the father's haplotypes, the computing server 130 may reconstruct a pair of haplotypes for each paternal grandparent using the haplotypes of at least two other siblings of the father. Similarly, the computing server 130 may reconstruct an ancestor's haplotypes based on the offspring's haplotypes.

### RECONSTRUCTING PARENTS' GENOMES USING Two SIBLINGS

In some situations, a target individual may wish to reconstruct their parents' genomes (given that, for example, the parents are no longer living and thus genomic testing is not available for them), but may only have a single sibling whose genotyping data and results are available in the data store 205. It has been surprisingly found that even in cases with as few as these two siblings, the parents' genomes may be reconstructed with surprising accuracy and to a highly surprising degree, i.e. a surprisingly high proportion of the parents' genomes can be reconstructed. This is made possible through a novel approach which utilizes the phased genomes of the two siblings to reconstruct phased parental genomes, which approach is described herein.

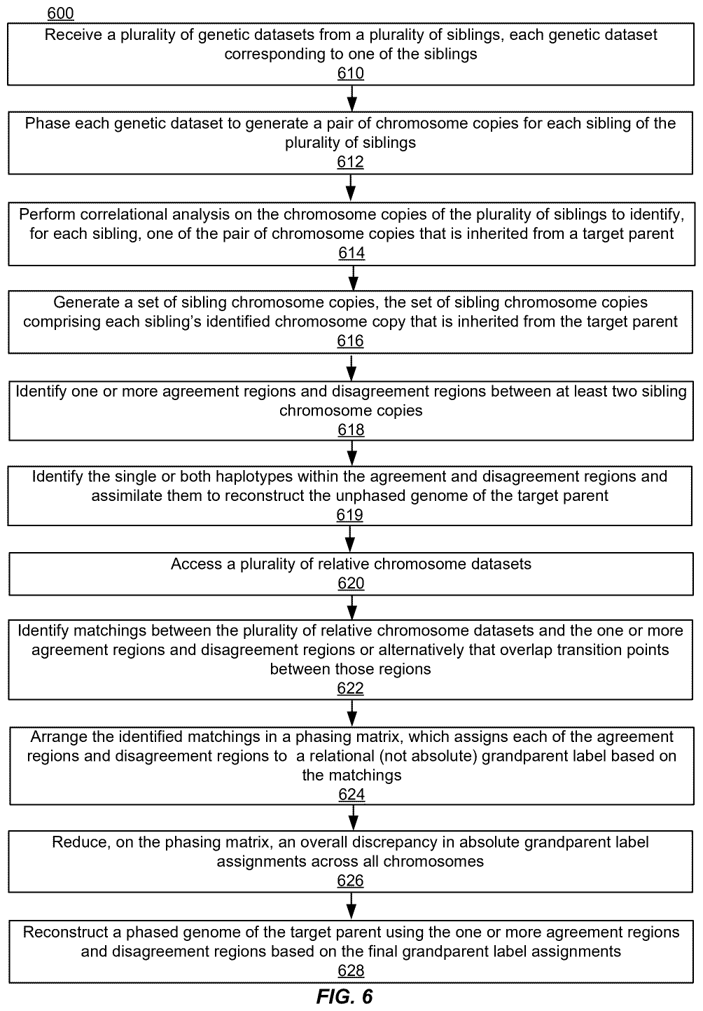

FIG. 6 is a flowchart depicting an example process 600 for reconstructing a parent's genome using children's genotype data, in accordance with some embodiments. The process may be performed by one or more engines of the computing server 130 illustrated in FIG. 2, such as the parental reconstruction engine 270. The process 600 may be embodied as a software algorithm that may be stored as computer instructions that are executable by one or more processors. The instructions, when executed by the processors, cause the processors to perform various steps in the process 600. In various embodiments, the process may include additional, fewer, or different steps. While various steps in process 600 may be performed with the use of computing server 130, each step may be performed by a different computing device.

In this disclosure, and as discussed above and herein, terms such as “genome,” “chromosome,” and “chromosome copy” are used. It should be noted that those terms do not necessarily imply the whole genome or the whole chromosome. The dataset that represents a genome or a chromosome copy may refer to merely a portion of the genome or a portion of the chromosome. The dataset may also be simplified. For example, a chromosome copy does not necessarily include every consecutive nucleotide site in a segment of the chromosome. A chromosome copy may include only SNP sites of interest. Those sites may correspond to the targeted sites extracted by the genetic data extraction service server 125 and/or the data formats maintained by the genetic data store 205, as discussed above. Hence, in some situations even when this disclosure refers to a whole genome, the data may include the simplified version of the whole genome.

In some embodiments, process 600 can include receiving a plurality of genetic datasets from a plurality of siblings (step 610). In some embodiments, the plurality of siblings may include two or more siblings. In some embodiments, the process 600 only requires the genetic datasets of two siblings to reconstruct phased genotypes of the parents. In some embodiments, data from additional siblings increases the accuracy and/or runtime of the process 600, but is not required. For the purpose of illustration, two siblings, S1 and S2, are used. It was surprisingly found that the use of data from two siblings alone can generate accurate unphased (or locally phased) reconstructed genotypes of the parents using the process 600. It was also surprisingly found that the use of data from two siblings along with some relatives (who may be only distantly related) who share IBD segments with one or more of the siblings can generate accurate genome-wide phased reconstructed genotypes of the parents using the process 600. These results are surprising because initially it would appear that data from two siblings are insufficient to determine in whom recombination events have occurred and to further deduce which genetic material from the grandparents was inherited by the parents.

The plurality of siblings may share the same pair of parents. In some embodiments, at least two of the siblings are full siblings who share the same two parents. In this example, the siblings inherit their genetic data from the same two parents. The respective genetic data may be referred to as paternal genetic data and maternal genetic data, or first parental genetic data and second parental genetic data if the parents' genders cannot be distinguished at certain stages. Each of the plurality of genetic datasets corresponds to one of the siblings and contains data on the whole or portions of the sibling's genome. In some embodiments, the genetic dataset may be in the form of diploid data that includes a sequencing of genotypes, for example, a pair of alleles present on two copies of a chromosome for a sibling. The genetic datasets may be any suitable datasets stored in genetic data store 205.

As discussed above regarding the reconstruction of a parent's genome from three siblings, a subset of the SNPs in a sibling's genome may be detected with SNP genotyping via microarray assessment, through DNA sequencing, or through other available methods for SNP assaying. In DNA sequencing, a laboratory assay or a massively parallel sequencing process may start with a primer that is bindable to sequences from both chromosome copies, but are not able to correlate the DNA sequence with chromosome copies inherited from the same parent. The inability to correlate chromosome copies with the two alleles of an identified SNP is also a limiting factor of SNP genotyping via microarray assessment. As a result, SNP genotyping often identifies a pair of alleles for a given position in the genome, but may not identify which allele corresponds to which haplotype, i.e., SNP genotyping does not identify the homomorphic chromosome (of the homomorphic pair) to which each allele corresponds. Thus, SNP genotyping produces an unordered or only locally ordered pair of alleles, where each allele corresponds to one of two haplotypes. As such, the computing server 130 may receive the genetic dataset of both siblings but the genetic data may be unphased or may only be phased at a very small (local) level.

Continuing with reference to FIG. 6, in some embodiments, process 600 can include phasing each genetic dataset to generate a pair of chromosome copies for each sibling of the plurality of siblings (step 612). The computing server 130 may use any suitable phasing algorithms of the phasing engine 220 to perform the phasing, which may include genome-wide phasing. For example, an IBD-phasing algorithm of the phasing engine 220 may generate a phasing result that has a long genomic distance accuracy and cross-chromosome accuracy in terms of haplotype separation. For each sibling, a pair of chromosome copies may correspond to a diploid dataset that may be phased into one pair of haploid data, i.e., two sets of haploid data or in some embodiments, two sets of chromosome copies. One set of haploid data corresponds to the genetic data from a first parent and the other set of haploid data corresponds to the genetic data from the second parent. In some embodiments, at the stage of the phasing result, the computing server 130 may separate the haploid data of the first parent from those of the second parent. However, the computing server 130 may not know which parent is paternal or maternal.

By way of example, FIG. 7A is a conceptual diagram illustrating the basic terms and concepts that are used in the process 600, in accordance with some embodiments. Similar to the discussion above regarding reconstruction of a parental genome from three siblings and as shown and described regarding FIG. 7A, one parent P1 having or associated with genotype data 710 and the other parent P2 having or associated with genotype data 720 have two children, who may be referred to as two full siblings (S1 and S2). Each one of the siblings (S1 and S2) inherits the genetic data from both parents. Each sibling respectively has a set of genotype data, which is collectively referred to as genotype data 730. In this disclosure, sometimes the genotype data 730 is further divided to denote a first set of chromosome copies inherited from a first parent and a second set of chromosome copies inherited from a second parent. These sets of chromosome copies are referred to as chromosome copies 730a and chromosome copies 730b for the first sibling and chromosome copies 730c and chromosome copies 730d for the second sibling, 730a and 730c referring to chromosome copies inherited from the first parent and 730b and 730d referring to chromosome copies inherited from the second parent. The process 600 reconstructs the genotype data (chromosome copies) 710 of the first parent P1 and the genotype data 720 of the second parent P2 from the genotype data 730. Both data 710 and 720 may not be possessed by the computing server 130. With respect to the genotype data 710, a first chromosome copy is inherited from the genetic data 706 of P1's parent, i.e., a first grandparent of the two full siblings S1, S2 (GP1) and the other chromosome copy is inherited from the genetic data 708 of P1's other parent, i.e., a second grandparent of the two full siblings S1, S2 (GP2).

Similarly, for the second set of genotype data 720, one chromosome copy is inherited from the genetic data of P2's parent, i.e., a third grandparent (GP3) and the other chromosome copy is inherited from the genetic data of P2's other parent, i.e., the fourth grandparent (GP4).

Here, and as discussed above, it should be noted that “paternal” and “maternal” are sometimes used to differentiate the two parents of the siblings for clarity of description but the actual gender of the parents may not be known by the computing server 130 based on analyzing the genetic data of the siblings. Similarly, “grandfather” and “grandmother,” may sometimes be used to differentiate the grandparents for clarity of description but the precise gender of the grandparent may not be known by reviewing the haplotype data. While the gender may not be known initially by the computing server 130, such labels may be added to the appropriate parents once known and/or when added or specified, e.g. by one of the full siblings S1, S2.

Each parent's pair of chromosomal copies (each copy inherited from one of the two grandparents) are recombined and passed to the child (S1 and S2) to form the child's corresponding genome. For example, the pair of chromosome copies that correspond to the first set of genotype data 710, with each chromosome from one of the grandparents GP1 and GP2, are recombined and passed to one of the siblings (e.g., S1) to form the first set of chromosome copies (e.g., 730a). Likewise, the pair of chromosome copies that correspond to the second genotype dataset 720, with each chromosome from one of the grandparents GP3 and GP4, are recombined and passed to the sibling S1 to form the second set of chromosome copies (e.g., 730b). The other sibling S2 has genotype datasets 730c, 730d similar to the chromosome copies 730a and 730b. The genotype dataset of the other sibling S2 is also inherited from the two parents P1, P2 but most often will have different recombination points compared to the chromosome copies 730a and 730b.

Similarly, the genotype data of each grandparent is inherited from the grandparent's parents, i.e., great grandparents. Take grandparent GP1 as an example: GP1 has genotype data 706 that is inherited from a pair of great grandparents of the siblings S1, S2, GGP1 and GGP2, with corresponding genotype data 702 and 704, respectively.

Other relatives in the family, if their genetic data are available to the computing server 130, may also provide information in the reconstruction of P1 and/or P2's genome. For example, the siblings S1 and S2 may have a second cousin from the parent P1's side, e.g., the siblings and the second cousin share at least one of the great grandparents GGP1 and/or GGP2. The siblings and the second cousin may share one or more IBD segments through these great grandparents, i.e., the second cousin's genotype data 750a and 750b may share IBD segments with the genotype data of S1 (i.e., 730a and 730b) and S2 (i.e., 730c and 730d). Likewise, the second cousin may share IBD segments with the parent P1 and the grandparent GP1. As will be discussed herein, it has been surprisingly discovered that such matches are doubly advantageous in that they are i) more abundant in the genetic data store 205 than closer relatives and hence more likely to be available for an average DNA test taker, and b) dispositive regarding an origin of IBD, as they only share a single great grandparent, thereby allowing for linking a particular matched segment—and a section of a genome of which that matched segment is a part—to a particular family side for a test taker.

In this disclosure, a cousin may be referred to as any relative who shares IBD segments with one or more siblings, parents, and/or grandparents. For example, the cousin may share a common ancestor with the family members. The term “cousin” in this context is generation independent and is to be interpreted broadly. Hence, relatives such as aunt and uncle may be referred to herein as cousins; however, the genome of an aunt or uncle or similar relative sharing IBD with both grandparents on a parental side may be used in a separate manner by first genome-wide phasing the aunt or uncle or similar relative's genome and then utilizing only the haploid genome having shared IBD. In some embodiments, a cousin may simply be referred to as a relative and may be identified by the computing server 130 from a database of over 1 million individuals. The computing server 130 may apply IBD estimation engine 225 on those individuals and identify relatives who have a certain amount of threshold (e.g., total length of at least 6 cM) of IBD segments and/or total shared IBD shared with one of the siblings as the relative.

In some embodiments, while the first set of genotype data 710 and the second set of genotype data 720 are illustrated in FIG. 7A, the computing server 130 may not have the first set of genotype data 710 or the second set of genotype data 720 because neither parent may be users or DNA testers with data available to the computing server 130. The process 600 may reconstruct the genotype data of one or both parents P1, P2 using the genotype data of the siblings S1 and S2 (730a, 730b, 730c, 730d). In some embodiments, the reconstruction from or using the genotype data of the siblings S1, S2 may generate unphased or locally phased genotype data, partially phased genotype data, and/or genome-wide phased genotype data of the parents P1, P2. The two siblings S1, S2 may be users or DNA testers with data available to the computing server 130 so that the computing server 130 may have the genetic data of both siblings S1, S2 stored in the genetic data store 205.

The diploid dataset 730 of the sibling S1 may be genome-wide phased to generate a pair of chromosome copies 730a and 730b, which were inherited from the parents' genotype data 710 and 720 respectively, although at this stage, it is not determined which set of chromosome copies 730a or 730b is from which diploid dataset 710 or 720.

Using the phasing engine 220, the computing server 130 may perform the phasing process for each genetic dataset for each sibling. In one example, for Chr1, the computing server 130 may phase the diploid dataset of each sibling to generate a pair of chromosome copies for each sibling which may be genome-wide phased. For example, for two siblings S1 and S2, the corresponding chromosome copies generated during phasing may be 730a and 730b for S1 and 730c and 730d for S2. Similarly, the computing server 130 may phase the diploid dataset for other pairs of chromosomes. In one example, the computing server 130 may generate 22 pairs of haplotype data, each pair of haplotype data corresponding to one pair of autosomal chromosome copies. For two siblings S1 and S2, the computing server 130 may generate 22×2 pairs of haplotype data (e.g., chromosome copies). As above, while 22 pairs of haplotype data corresponding to human autosomes are described, it will be appreciated that this is merely exemplary and the disclosure may extend to any suitable number of chromosomes and beyond diploidy.

Continuing with reference to FIG. 6, in some embodiments, process 600 can include comparing, e.g. via correlational analysis, the chromosome copies of the plurality of siblings to identify one of the pair of chromosome copies that is inherited from a target parent for each sibling (step 614). For each sibling, each chromosome copy may correspond to a haplotype or part of a haplotype generated by a long-distance phasing algorithm. In one example, for two siblings S1 and S2, the genotype data correspond to four sets of chromosome copies, 730a, 730b, 730c, and 730d. To determine which two of the four sets of chromosome copies 730a, 730b, 730c, and 730d are inherited from a same parent, the computing server 130 may compare the four sets of chromosome copies to determine the highest correlation among and between the four sets of chromosome copies 730a, 730b, 730c, and 730d. In some embodiments, the computing server 130 may identify matched segments of genotype data between two siblings, e.g., comparing and identifying identical alleles at SNP sites in the phased haplotypes between two siblings. The computing server 130 may determine two sets of chromosome copies, one from each sibling, that are correlated and inherited from a same parent. Since the genotype data are from siblings who inherit the chromosome copies from the same parents, two of the four chromosome copies typically share long stretches of identical nucleotide sequences. Similarly, the other two of the four chromosome copies also share long stretches of identical nucleotide sequences. As such, based on identifying a highest correlation between the four sets of chromosome copies, the four chromosome copies are separated into two groups, one corresponding to each parent, respectively.

Continuing with reference to FIG. 6, in some embodiments, process 600 can include generating (step 616) a set of sibling chromosome copies. The set of sibling chromosome copies may include each sibling's identified chromosome copy that is inherited from a target parent. The target parent may be the first parent P1 or the second parent P2. The process for reconstruction of the genotypes of P1 may be repeated for corresponding data of P2 for the reconstruction for P2. As such, the target parent can be either P1 or P2. At this stage, whether the set of sibling chromosome copies is from the paternal or maternal parent is typically not determined, although such determination can be optional in some embodiments. The computing server 130 may re-label the two sets of sibling chromosome copies as SlPl and S2P1, indicating that the set of sibling chromosome copies is correlated to a same parent P1 (father or mother), and each corresponds to a particular sibling. The second set of chromosome copies may be labelled as S1P2 and S2P2, indicating that the set of sibling chromosome copies is correlated to a same parent P2 (mother or father), and each corresponds to a particular sibling.

As shown and described above, FIG. 4B is a conceptual diagram graphically illustrating a set of sibling chromosome copies that are inherited from a same parent, in accordance with some embodiments. The computing server 130 compares the haplotypes of the two siblings S1 and S2 for each pair of chromosome copies, and identifies one of the haplotypes that is inherited from a same parent for each sibling. As shown in FIG. 4B, for each chromosome, from Chr1 to Chr22, the haplotypes of the siblings are correlated based on the parent from whom the haplotypes are inherited. The haplotypes are re-labeled accordingly. For example, Chr1S1P1 indicates the set of haplotypes (i.e., chromosome copy) of the sibling S1, associated with Chr1, and inherited from the parent P1. Although which parent P1 or P2 is the paternal parent or maternal parent is not determined at this stage, the computing server 130 may identify the chromosome copy that is inherited from a same parent to generate a set of sibling chromosome copies. For example, with the correlation analysis, the sets of haplotypes, Chr1S1P1 and Chr1S2P1, are identified to be inherited from a same parent P1, and form a set of sibling chromosome copies for the parent P1. Similarly, the sets of sibling chromosome copies, Chr1S1P2 and Chr1S2P2, are identified to be inherited from a same parent P2, and form a set of sibling chromosome copies for P2. In some embodiments, the computing server 130 may identify, for each sibling, the chromosome copy that is inherited from a same parent for each of the 22 chromosomes and form a full set of sibling chromosome copies that were inherited from the same parent, i.e., P1 or P2. As shown in FIG. 4B, the chromosome copies of both siblings that are inherited from the parent P1 are assigned to the upper group while the chromosome copies of both siblings that are inherited from parent P2 are assigned to the lower group. Each group is an example set of sibling chromosome copies that are inherited from a same parent.

The top group in FIG. 4B may be analyzed by subsequent steps of process 600 to determine phasing of the genotypes of the first parent. The same subsequent steps of process 600 may be repeated for the second parent. From this step on, only one parent is discussed and the parent is referred to as the target parent.

In some embodiments, a siblings' relative, e.g., a second cousin, may share genetic data (e.g., IBD segments) with the siblings, and may be used to determine whether the set of sibling chromosome copies is inherited from a paternal parent or a maternal parent. Referring back to FIG. 7A, the genomes of the great grandparents GGP1 and GGP2 (shown in black color) are passed down to the offspring, e.g. via GP1 and GP1's sibling. The siblings S1 and S2 and a second cousin may share IBD segments through their great grandparents GGP1 and/or GGP2, but not through GP2. In some embodiments, the shared IBD segments of the second cousin may be found in one or more random locations in the genome. Since the genome for the other parent P2 is not related to the second cousin in this example, the computing server 130 may not identify any IBD with this second cousin's genome or may identify substantially less IBD with this second cousin's genome and the genotype data of the other parent P2, thereby allowing for more accurate calculation of the cross-chromosome correlation with the parent P1 genotype data.

Continuing with reference to FIG. 6, in some embodiments, process 600 can include identifying, from the set of sibling chromosome copies, one or more agreement regions and disagreement regions between at least two sibling chromosome copies (step 618). In some embodiments, genetic regions or chromosomes are assessed for long regions of genotype equality or for long regions of inequality, e.g., agreement regions and disagreement regions between the sibling chromosome copies. An agreement region is a region where the chromosome copy of the first sibling agrees or substantially agrees with the chromosome copy of the second sibling for nearly all nucleotides assessed in the region (occasional genotype errors are scattered throughout the assessment of the genome and may be present at low levels in any given region). This indicates that the agreement region is inherited from the same chromosome of the target parent. A disagreement region is a region where the chromosome copy of the first sibling is different from the chromosome copy of the second sibling for a non-trivial number of nucleotides assessed in the region (some alleles will be identical due to chance, which chance can be high for any individual SNP that may have a high allele frequency for a given ethnicity—but assessing many SNPs reduces the likelihood that a region will be all in agreement or mostly in agreement due to chance alone, or due to the presence of very small shared haplotypes from very distant ancestors). This indicates that, in the disagreement region, the first sibling inherited the genetic material from the first chromosome of the target parent and the second sibling inherited the genetic material from the second chromosome of the target parent.

In some embodiments, the length of an agreement/disagreement region may be at least 100 SNPs or some other specified amount. In other words, “long” regions of equality or inequality may require identity for at least 100 SNPs, though the disclosure is not limited thereto. In some embodiments, the length of an agreement/disagreement region may be identified in terms of cM. In some embodiments, a switch between an agreement region and a disagreement region may indicate that either a recombination breakpoint has occurred in either one of the two siblings, a region of identical-by-state (IBS) has begun or ended, or a rare artifactual anomaly has occurred.

Continuing with reference to FIG. 6, in some embodiments, process 600 can include identifying the single haplotype or both haplotypes within the agreement and disagreement regions and assimilate them to reconstruct the unphased (or locally phased) genome of the target parent (step 619). The identification of these switch points between the agreement/disagreement regions allows for a division of a chromosome into distinct regions. Each of these regions may be re-assessed and labeled for equality of genotype or inequality of genotype between the two siblings. For example, in regions of disagreement, both grandparental haplotypes are present between the two siblings; in regions of equality, only one grandparental haplotype may be concluded with this information alone. Regions of inequality yield two alleles for the unphased (or locally phased) target parent reconstructed genome, whereas regions of equality yield one allele for the unphased (or locally phased target parent reconstructed genome. The summation of all of these regions across all regions and chromosomes yields the unphased (or locally phased) reconstructed genome of the target parent.

In one example, for a particular parent P1's pair of chromosome copies, one set of chromosome copies is from one grandparent (e.g., GP1) and the other set of chromosome copies is from the other grandparent (e.g., GP2). The GP1 chromosome copies and GP2 chromosome copies break and recombine in P1 to pass to the child, e.g., S1, to form one set of the child's chromosome copies that is inherited from the parent P1. The recombined chromosome copies for each of the siblings S1 and S2 may be different, having different portions of the GP1 and GP2 chromosome copies due to different recombination events, resulting in the various agreement and disagreement regions between the sibling chromosome copies.

It was surprisingly found that the use of agreement regions and disagreement regions was generally more effective and accurate in reconstructing and determining genome-wide phasing of the target parent's genome instead of an alternative approach that relies on IBD overlap with recombination breakpoints (discussed as a separate embodiment), as this facilitates the identification and reliance upon a vastly larger corpus of potential matches with segments of IBD with the two siblings that can be matched to the two siblings within a zone demarcated by adjacent recombination points or switch points, as opposed to necessarily identifying and relying upon matches with IBD that overlap exact recombination breakpoints. This is particularly advantageous for individuals with few matches in the genetic data store 205 due to a paucity of matches in the individuals' region, community, ethnicity, etc., and/or where the individual is new to direct-to-consumer genetic testing in comparison to their relatives.

FIG. 7B shows an example portion of a set of sibling chromosome copies, in accordance with some embodiments. As shown in FIG. 7B, the set of sibling chromosome copies, Chr1S1P1 and Chr1S2P1, are inherited from a target parent (e.g., P1). In FIG. 7B, only one chromosome is shown but the process may be used for additional chromosomes. As mentioned, this process may be repeated for the chromosome copies inherited from P2. In this example, each of the chromosome copies includes portions of the GP1 chromosome copy and portions of the GP2 chromosome copy in different patterns as indicated by the switch points.

The computing server 130 may compare the sequence of alleles for the set of sibling chromosome copies and identify one or more agreement and disagreement regions. As shown in FIG. 7B, the computing server 130 identifies regions 1 and 3 as agreement regions between the set of sibling chromosome copies (Chr1S1P1 and Chr1S2P1), and regions 2 and 4 as disagreement regions between the set of sibling chromosome copies (Chr1S1P1 and Chr1S2P1) (the allele sequences are denoted by various filled patterns). The computing server 130 may determine that region 1 of the sibling chromosome copies (Chr1S1P1 and Chr1S2P1) is inherited from the same grandparent and region 3 of the sibling chromosome copies (Chr1S1P1 and Chr1S2P1) is inherited from the same grandparent. At this stage, however, the computing server 130 may not be able to identify whether region 1 and region 3 are inherited from the same grandparent, based on the genotype information of two siblings only. Similarly, the computing server 130 may identify that region 2 (or region 4) in S1's chromosome copy and S2's chromosome copy are inherited from different grandparents, but may be not able to identify from which grandparent each chromosome copy is inherited. Without a third sibling to overlap breakpoints, it is highly difficult to disambiguate the sources of the grandparent haplotypes.

In some embodiments, the computing server 130 may additionally use various ways to determine the corresponding grandparent. In some embodiments, one or more relatives' genotype data may be used to identify whether a region of a chromosome copy is inherited from GP1 or GP2. In some examples, the computing server 130 may access information such as a family tree, ethnicity, community assignment, and linkage to determine the grandparent relationship of the target parent's chromosome copies.

Continuing with reference to FIG. 6, in some embodiments, process 600 can include accessing a plurality of relative chromosome datasets (step 620). The relatives in this context may be referred to as matches, genetic matches (e.g., someone who shares IBD segments exceeding a threshold cM), or cousins. In some embodiments, each reference chromosome dataset belongs to a relative that shares genetic data with the target parent. In some embodiments, the relative's chromosome dataset may be one or more portions of haplotypes. In some embodiments, the relative's chromosome dataset may include one or more portions of haplotypes for one or more chromosomes.

In some embodiments, the relative may be an individual that shares genetic material with both grandparents on the paternal or maternal side. In some embodiments, the relative may be an individual that shares genetic material with both the paternal and maternal parent. For example, the relative may be siblings, first cousins, second cousins, and offspring in some cases that are related to both the paternal and maternal parent. In some embodiments, if desired to include an individual who shares genetic material with both grandparents or closer (e.g. an aunt or uncle or first cousin), their genetic data may be phased and only the haploid data corresponding to a single side may be used for this part of the procedure. The computing server 130 may use the relative chromosome datasets to identify shared IBD segments across one or more of the sibling chromosome copies. In some cases, not all relatives share IBD segments with only one of the parents or with only one of the grandparents. Hence, in some embodiments, such shared IBD segments across both parental sides is determined and used as a filter in deciding the value of including a relative's IBDs in calculation of the cross-chromosome correlations. As a result, certain matches, such as matches hailing from multiple grandparents, may be down-weighted.

Continuing with reference to FIG. 6, in some embodiments, process 600 can include identifying matches between each of the possible plurality of relative chromosome datasets and portions within the one or more agreement regions and disagreement regions (step 622). In some embodiments, the computing server 130 may identify the locations of the matched segments (e.g., shared IBD segments) of the relative chromosome datasets relative to the siblings' chromosome copies. For example, the computing server 130 may access the chromosome datasets of a second cousin of the siblings and determine whether the second cousin has matching segments with the siblings. In one example, the second cousin may share matching genetic portions (e.g., IBD segments) with a sibling (e.g., S1) exclusively on one side of the phased sibling's genome. In another example, where a relative has shared IBD segments on both sides of the sibling's genome, such relatives are excluded or may be given a lower weight or treated in a separate algorithmic fashion for their shared phased haploid data. This is because the relative may have shared inheritance with both the mother and father of the sibling and may be uninformative about the shared correlation of inheritance across genomic regions particularly as to disambiguation of grandparents. As illustrated in FIG. 7B, the computing server 130 may identify one or more shared IBD segments (e.g., R-a to R-f) between the relative chromosome datasets and portions within the agreement regions and disagreement regions in the sibling chromosome copies. A given relative (e.g., Match 1) may have multiple IBD segments (e.g. R-a and R-b) matching to a sibling, e.g. S1, on a chromosome or across multiple chromosomes. If the relative shares genetic material with only a single grandparent (e.g., 2^{nd} cousin, or if using the phased haploid data from a closer relative (e.g., aunt or uncle)), each of the regions in which that relative shares an IBD segment with one of the siblings necessarily will have been inherited from that grandparent. In regions of disagreement, it may be inferred that the genetic material of the sibling for whom the match did not occur was inherited from the other grandparent.

For example, if the IBD segments R-a and R-b of Match 1 to S1 are with the same 2^{nd} cousin or further relative, this may indicate that the genetic material in regions 1 and 2 of S1 were inherited from the same grandparent. Through inference, the genetic material in region 2 of S2 will have been inherited from the other grandparent (and for this example it can be determined that the genetic material in region 1 of that other grandparent was not inherited by either S1 or S2 and hence is not able to be determined from the two siblings alone). These relational assignments of inherited genetic material from either grandparent in the identified regions surprisingly are highly accurate and may be entered into a phasing matrix (described below and shown in FIG. 7C), though at this point only arbitrary relational assignments of grandparent labels may be made (i.e. in region 2 the genetic material inherited by S1 may be given the label GP1 and the genetic material inherited by S2 in that region may be given the label GP2—but the actual absolute labels for S1 and S2 may be GP2 and GP1 respectively. This same procedure may be applied to other relatives who share IBD with one or more of the siblings (e.g. Match 2 may have shared IBD segments with S2 in region 2 and region 3; Match 3 may have shared IBD segments with S2 in region 1 and region 4). In some embodiments, a shared IBD segment (e.g., R-a) may include substantial overlap with an agreement region and/or a disagreement region. A shared IBD segment may be filtered based on a threshold (e.g., at least 100 contiguous SNPs) in order to be considered substantially overlapping with a sibling's chromosome copy. In some embodiments, while a certain minimum degree of overlapping may be imposed, a shared IBD segment does not need to overlap with an agreement/disagreement region entirely and may extend across regions. Many of the shared IBD segments can be shorter than a region.

Continuing with reference to FIG. 6, in some embodiments, process 600 can include arranging the identified matchings in a phasing matrix (step 624). In some embodiments, at least two or more regions having IBD matchings anywhere across the genome with a same relative must occur for a relative to be utilized in the phasing matrix (this requirement of two or more regions may be necessary to provide leverage in solving for the absolute relationships via optimization as discussed later). The phasing matrix assigns each of the agreement regions and disagreement regions to an arbitrary grandparent labeling (GP1 or GP2) based on the relational matchings being located in agreement or disagreement regions. In some examples, the arbitrary grandparent labeling may be referred to as a relational (not absolute) grandparent label, since they are assigned based on the relational matchings. In some embodiments, a relative's relationship to the siblings is known, e.g., a second cousin from the GP1 side, but this knowledge is advantageously not a requirement. The computing server 130 may label the regions with matching segments with the corresponding grandparent label, GP1 or GP2, based on this relative's chromosome datasets. In some embodiments, where a relative's relationship to the siblings is unknown, the computing server 130 may not be able to identify whether the IBD regions are from GP1 or GP2. In some embodiments, the computing server 130 may label each agreement region and disagreement region with GP1 or GP2 and record the relational (not absolute) labeling in a phasing matrix using the chromosome datasets of all desired relatives.

FIG. 7C illustrates example phasing matrices each of which may also be termed as a “Match-Sib Correlated Bi-rows Matrix,” in accordance with some embodiments. The phasing matrix 762 may be constructed by the identification of matching regions as illustrated in FIG. 7B but the grandparent labels for each bi-row are initially assigned arbitrarily. Using the identified shared genomic regions with relatives, the computing server 130 may record or populate an initial phasing matrix 762. For example, the matrix 762 may include a number of columns equal to the total number of unique genomic regions created by the switch points (e.g., agreement regions and disagreement regions). In some embodiments, approximately 100 regions may be identified in this manner, though this number may vary.

The number of rows corresponds to the number of relatives exclusive to a single grandparental side multiplied by the number of siblings (which in this example is two, hence bi-rows are created). The computing server 130 may repeat this process for both siblings with each relative-to-sibling matching contributing as a unique bi-row. Within each bi-row is contained the correlative implications of any two given genomic regions being regions that for the first region are equal or unequal (i.e., in agreement or disagreement) between the two siblings and for the second region are also equal or unequal. The first row within a bi-row grouping may correspond to the first sibling (S1) and the corresponding cell entries for the currently recorded grandparent phase estimation (GP1 or GP2); the second row within a bi-row grouping may correspond to the same information for the second sibling (S2). Hence, initially, all individual bi-rows will have high accuracy in a relational sense, but not in an absolute sense. All regions which are identified as being in IBD for the given relative are then filled out within the bi-rows within the cells corresponding to the given regions the IBD has occurred within (and of a sufficient minimum length, e.g. 100 SNPs). By extension, this approach performed using bi-rows for two siblings can be applied to the situation of reconstructing a parent genome from three or more siblings by calculating and recording the equal or unequal region information for additional siblings in additional adjacent rows (multi-rows, as opposed to bi-rows) of a phasing matrix which may all be permuted simultaneously in a similar fashion as illustrated for bi-rows.

In some embodiments, the first region having an IBD overlap with a match tied to the great grandparents corresponding to GP1 (e.g. the second cousin shown in FIG. 7A) may be assigned as GP1. The other three cell entries of the bi-row and two region columns are then filled in by using the equality logic described herein (e.g., the other region with IBD and the same siblings having the match may also be labeled as GP1). The corresponding cell entries for the second sibling for the two regions will be either GP1 or GP2 based on the equality information between those two regions. It may be noticed that if all utilized match relatives are to only one side of the grandparent, all matched regions may be assigned with GP1. Thus, in the example of FIG. 7B, a bi-row may be generated for S1 and S2 vis-a-vis Match 1 (the second cousin), who shares IBD with both S1 and S2 in region 1 and shares IBD with only S1 in region 2 (not with S2 in region 2); the bi-row here may be populated as shown below in Table 1.

TABLE 1

| | | | |
|---|---|---|---|
| Region 1 | Region 2 | Region 3 | Region 4 |

| | | |
|---|---|---|
| Match 1-S1 | GP1 | GP1 |
| Match 1-S2 | GP1 | GP2 |

As seen, Match 1 is not informative regarding Regions 3 and 4 because it does not share IBD therewith; but it can be logically inferred according to the disclosed embodiments that Region 1 in both S1 and S2 is the same and come from the same grandparent (as they have equality therebetween) and that Region 2 in S1 and S2 are not the same and do not come from the same grandparent (as they do not have equality therebetween); given that Match 1 is a second cousin likely tied to the Siblings S1, S2 only through GP1, the system may first populate this bi-row with GP1 as the label for Regions 1 and 2 for S1, and GP1 as the label for Region 1 and GP2 as the label for Region 2 for S2. This procedure may be repeated for each match of the siblings, which may include a plurality of matching regions across a plurality of chromosomes for potentially thousands of matches.

Continuing with reference to FIG. 6, in some embodiments, process 600 can include reducing through an optimization method, on the phasing matrix, an overall discrepancy in the absolute grandparent assignments across all chromosomes (step 626). The grandparent assignment that is determined based on the overall discrepancy across all chromosomes may be referred to as absolute assignments. In some embodiments, the computing server 130 may apply an optimization algorithm on the phasing matrix to minimize an objective function which may include the number of disagreements within a column and across all columns. In some embodiments, the disagreement objective may be a pure sum or may be a weighted reflection of disagreement or agreement based on the degree of closeness of a relative, the number of shared IBD segments, or the total length of IBD segments. The assessments of the disagreement objective may be in terms of cM, or other genetic-related metrics. The objective function of the algorithm may be defined as the disagreement objective, or conversely, the agreement objective. The optimization algorithm may include multiple rounds of iterations that attempt to switch the label assignment of each bi-row to determine whether the objective goal as reflected by how the objective function is defined improves. The optimization algorithm may utilize or include grid search, random search, steepest descent, or any other suitable modality.

In one example, the computing server 130 may determine that while for any given bi-row there is a slight possibility of some relational inaccuracy, most of the entries will be accurate in a relational sense. Hence, from a given starting point (which may judiciously be chosen to be the bi-row having the largest number of entries, such as a match with the greatest number of IBD segments with the siblings), truth is initially taken for each of these entries in the bi-row. Then for the next selected bi-row, all overlapping cell entries with the previous truth level are assessed to determine if there are more entries in agreement with truth or in disagreement. By “overlapping,” the computing server 130 may search for a subsequent match wherein at least one column, i.e. region, is common between the matches in order to determine agreement or disagreement. If the majority are in disagreement, all cell entries for that bi-row are inverted (e.g. all GP1s become GP2s and all GP2s become GP1s), and then the inverted positions are evaluated to determine whether the permutation improves the overall agreement. In some examples, only bi-rows having a cell entry in a column currently having a truth value may be considered for assessment. In some embodiments, the computing server 130 may iteratively repeat the assessment to account for all usable bi-rows. Upon each iteration with a new bi-row, the truth answer may be updated for any given column in which a new majority (pure or weighted) is identified. The computing server 130 may obtain a final phasing matrix 764 which includes a solution 766 to the sibling bi-row matrix. The solution may include grandparent assignment for each of the agreement regions and disagreement regions in the sibling chromosome copies.

This phasing approach advantageously and surprisingly utilizes particular relatives of siblings to determine a grandparental haplotype associated with each region of a plurality of determined regions in each haplotype for each of the siblings, facilitating the attribution of reconstructed grandparental haplotypes to particular parents, with the capability of showing users an unprecedented proportion of their parents' genomes in a manner that does not require either parent to have contributed a DNA sample to the genealogical research service. It has been surprisingly found that the above-described approach advantageously facilitates high accuracy (greater than 95% accuracy for greater than 99.7% of sibling pairs, and greater than 98% accuracy for greater than 97% of sibling pairs), with a close adherence to the theoretical expected mean of maximal reconstruction proportions possible from two siblings (theoretical: 50% of SNPs having both alleles of a reconstructed parent identified; 75% of total reconstructed parent alleles identified; observed in the reconstruction of 2,000 research consented quartets: median of 50.9% (IQR: 47.4-54.3%, range: 28.2-67.8%) of SNPs having both alleles of the reconstructed parent identified; median of 75.4% (IQR: 73.7-77.2%, range 64.1-83.9%) of total reconstructed parent alleles identified).

In another embodiment for the situation when there are only two siblings, beginning with step 622, IBD matches which overlap the transition point between agreement and disagreement regions may be utilized. This alternative approach assesses all IBD matches of the siblings in the genetic database to find relatives who match at a transition point from an agreement region to a disagreement region (or vice-versa) and have a sufficient number of SNPs (e.g., 50 SNPs) or genetic length overlapping the transition point on both sides of the transition point. When this occurs, the IBD match of the relative serves as a surrogate third sibling, and as such, may be used to infer through voting in which of the two siblings the recombination breakpoint occurred (it will have occurred in the sibling not sharing the IBD match across the breakpoint). Then, initial arbitrary grandparent labels may be assigned with a switch in the grandparent label for the sibling region which had the identified recombination breakpoint, and this information may be entered into a data matrix. This alternative approach can be seen in FIG. 7D which depicts a generalization of this embodiment. For example, the IBD segments R-g, R-h, and R-i each correspond to an IBD matching segment (Match 1, Match 2, and Match 3, respectively) from a different relative, each of which overlaps a recombination breakpoint in one of the two siblings (S1 and S2). As Match 1 is an IBD match to S1, this implies that the recombination breakpoint occurred in S2, and hence the initial haplotype of one grandparent (arbitrarily labeled as GP1) that was shared by both S1 and S2 in region 1 switches to the haplotype from the other grandparent (GP2) in region 2 for S2 (and implies that S1 contains the haplotype for GP1 in region 2). Likewise, as Match 2 is an IBD match to S2, this implies that the next recombination breakpoint occurred in S1, and hence region 3 contains the single haplotype for GP2 by both S1 and S2. Finally, the Match 3 IBD match to S1 implies that the third recombination breakpoint occurred in S2, and hence in region 4 sibling S1 contains the haplotype for GP2 and sibling S2 contains the haplotype for GP1. The arbitrary but correlated grandparent labels across the regions may also be entered into a phasing matrix.

Continuing with reference to FIG. 6, in some embodiments, process 600 can include reconstructing a genome-wide phased genome of the target parent using the one or more agreement regions and disagreement regions based on the grandparent assignment from either the optimal solution from bi-row permutation or from the optimal solution from single-row permutations (step 628). The grandparent assignment may be determined from the result of the phasing matrix. In some embodiments, the computing server 130 may rearrange the assigned regions of chromosome copies related to one grandparent to construct the genome related to the other grandparent. In some embodiments, the computing server 130 may rearrange portions of the haplotypes based on the sequence of alleles at the SNP sites.

In some embodiments, the reconstruction may be limited locally within a chromosome. Yet, in some embodiments, the reconstruction may be a genome-wide reconstruction of the target parent genome or a measurable portion of the target parent genome occurring across multiple or all chromosomes. Here, as illustrated, from Chr1 to Chr 22, the computing server 130 is able to recover a majority of the target parent's genome. In some embodiments, the genome here refers to at least 1% of the entire human genome. In some embodiments, the genome here refers to at least 5% of the entire human genome. In some embodiments, the genome here refers to at least 10% of the entire human genome. In some embodiments, the genome here refers to at least 20% of the entire human genome. In some embodiments, the genome here refers to at least 30% of the entire human genome. In some embodiments, the genome here refers to at least 40% of the entire human genome. In some embodiments, the genome here refers to at least 50% of the entire human genome. In some embodiments, the genome here refers to at least 60% of the entire human genome. In some embodiments, the genome here refers to at least 70% of the entire human genome. In some embodiments, the genome here refers to at least 80% of the entire human genome. In some embodiments, the genome here refers to at least 90% of the entire human genome. In some embodiments, the genome here refers to at least 95% of the entire human genome. In some embodiments, the genome here refers to at least 99% of the entire human genome. In some embodiments, the genome here refers to 100% of the entire human genome.

In some embodiments, the computing server 130 reconstructs the genome related to GP1 using the phased chromosome copies that are determined to be inherited from the same grandparent, e.g., GP1. Similarly, the computing server 130 may reconstruct the genome related to GP2 using the phased chromosome copies that are determined to be inherited from the same grandparent, e.g., GP2. In this way, the computing server 130 reconstructs both chromosome copies (e.g., grandfather haplotypes and grandmother haplotypes) for the target parent P1 using the set of sibling chromosome copies. A similar process may be used to reconstruct both chromosome copies for the other parent P2 of the siblings.

In embodiments, the process 600 may be repeated for a plurality of sibling pairs corresponding to two parents. That is, as an alternative to the three-sibling or more parental genome reconstruction modalities corresponding to FIG. 3 above, or in addition thereto, the process 600 may be performed on different combinations of two siblings from a family of 3 or more siblings to reconstruct the parents' genome.

### Example Machine Learning Models

In various embodiments, a wide variety of machine learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used. For example, the phasing of haplotypes of the target parent across chromosomes as discussed in FIG. 4E and other processes may apply one or more machine learning and deep learning techniques.

In various embodiments, the training techniques for a machine learning model may be supervised, semi-supervised, or unsupervised. In supervised learning, the machine learning models may be trained with a set of training samples that are labeled. For example, for a machine learning model trained to perform cross-chromosome phasing, the training samples may be a plurality of haplotypes that phasing across chromosomes are known and associated IBD matches.

By way of example, the training set may include multiple past genetic data with known outcomes. Each training sample in the training set may correspond to a past and the corresponding outcome may serve as the label for the sample. A training sample may be represented as a feature vector that include multiple dimensions. Each dimension may include data of a feature, which may be a quantized value of an attribute that describes the past record. In various embodiments, certain pre-processing techniques may be used to normalize the values in different dimensions of the feature vector.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In some embodiments, in cross-chromosome phasing, the objective function may correspond to identifying the maximum number of shared Identity by Descent Regions (IBDs). In various embodiments, the error rate may be measured as cross-entropy loss, L1 loss (e.g., the sum of absolute differences between the predicted values and the actual value), L2 loss (e.g., the sum of squared distances).

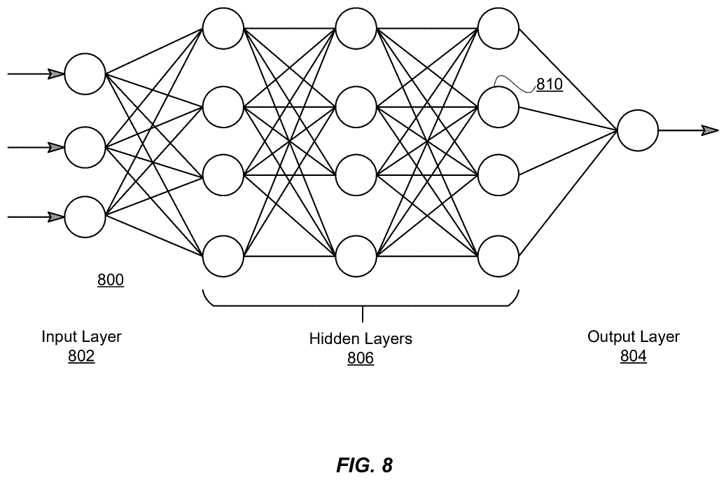

Referring to FIG. 8, a structure of an example neural network is illustrated, in accordance with some embodiments. The neural network 800 may receive an input and generate an output. The input may be the feature vector of a training sample in the training process and the feature vector of an actual case when the neural network is making an inference. The output may be the prediction, classification, or another determination performed by the neural network. The neural network 800 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layer and pooling layer may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one embodiment, one or more custom layers may also be presented for the generation of a specific format of the output. For example, a custom layer may be used for image segmentation for labeling pixels of an image input with different segment labels.

The order of layers and the number of layers of the neural network 800 may vary in different embodiments. In various embodiments, a neural network 800 includes one or more layers 802, 804, and 806, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine learning model may include certain layers, nodes 810, kernels and/or coefficients. Training of a neural network, such as the NN 800, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine learning model may include an iterative process that includes iterations of making determinations, monitoring the performance of the machine learning model using the objective function, and backpropagation to adjust the weights (e.g., weights, kernel values, coefficients) in various nodes 810. For example, a computing device may receive a training set that includes a plurality of haplotypes. Each training sample in the training set may be assigned with labels indicating whether a shared IBD is identified between two or more sets of haplotypes. The computing device may adjust, in a backpropagation, the weights of the machine learning model based on the comparison. The computing device backpropagates one or more error terms obtained from one or more loss functions to update a set of parameters of the machine learning model. The backpropagating may be performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for performing cross-chromosome phasing or another suitable task for which the model is trained.

### Computing Machine Architecture

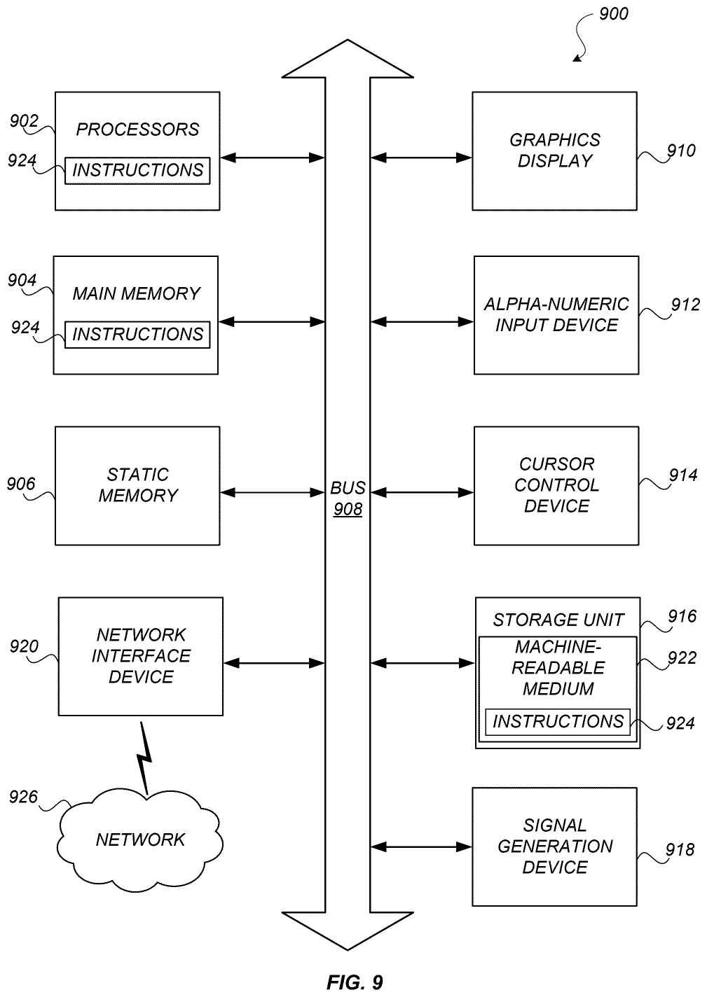

FIG. 9 is a block diagram illustrating components of an example computing machine that is capable of reading instructions from a computer-readable medium and execute them in a processor (or controller). A computer described herein may include a single computing machine shown in FIG. 9, a virtual machine, a distributed computing system that includes multiple nodes of computing machines shown in FIG. 9, or any other suitable arrangement of computing devices.

By way of example, FIG. 9 shows a diagrammatic representation of a computing machine in the example form of a computer system 900 within which instructions 924 (e.g., software, source code, program code, expanded code, object code, assembly code, or machine code), which may be stored in a computer-readable medium for causing the machine to perform any one or more of the processes discussed herein and may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 9 may correspond to any software, hardware, or combined components shown in FIGS. 1 and 2, including but not limited to, the client device 110, the computing server 130, and various engines, interfaces, terminals, and machines shown in FIG. 2. While FIG. 9 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 924 that specify actions to be taken by that machine. Further, while only a single machine is illustrated, the term “machine” and “computer” may also be taken to include any collection of machines that individually or jointly execute instructions 924 to perform any one or more of the methodologies discussed herein.

The example computer system 900 includes one or more processors 902 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 900 may also include a memory 904 that store computer code including instructions 924 that may cause the processors 902 to perform certain actions when the instructions are executed, directly or indirectly by the processors 902. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One and more methods described herein improve the operation speed of the processors 902 and reduces the space required for the memory 904. For example, the database processing techniques and machine learning methods described herein reduce the complexity of the computation of the processors 902 by applying one or more novel techniques that simplify the steps in training, reaching convergence, and generating results of the processors 902. The algorithms described herein also reduces the size of the models and datasets to reduce the storage space requirement for memory 904.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though the specification or the claims may refer to some processes being performed by a processor, this should be construed to include a joint operation of multiple distributed processors.

The computer system 900 may include a main memory 904, and a static memory 906, which are configured to communicate with each other via a bus 908. The computer system 900 may further include a graphics display unit 910 (e.g., a plasma display panel (PDP), a liquid crystal display (LCD), a projector, or a cathode ray tube (CRT)). The graphics display unit 910, controlled by the processors 902, displays a graphical user interface (GUI) to display one or more results and data generated by the processes described herein. The computer system 900 may also include alphanumeric input device 912 (e.g., a keyboard), a cursor control device 914 (e.g., a mouse, a trackball, a joystick, a motion sensor, or other pointing instruments), a storage unit 916 (a hard drive, a solid-state drive, a hybrid drive, a memory disk, etc.), a signal generation device 918 (e.g., a speaker), and a network interface device 920, which also are configured to communicate via the bus 908.

The storage unit 916 includes a computer-readable medium 922 on which is stored instructions 924 embodying any one or more of the methodologies or functions described herein. The instructions 924 may also reside, completely or at least partially, within the main memory 904 or within the processor 902 (e.g., within a processor's cache memory) during execution thereof by the computer system 900, the main memory 904 and the processor 902 also constituting computer-readable media. The instructions 924 may be transmitted or received over a network 926 via the network interface device 920.

While computer-readable medium 922 is shown in an example embodiment to be a single medium, the term “computer-readable medium” should be taken to include a single medium or multiple media (e.g., a centralized or distributed database, or associated caches and servers) able to store instructions (e.g., instructions 924). The computer-readable medium may include any medium that is capable of storing instructions (e.g., instructions 924) for execution by the processors (e.g., processors 902) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g., method, can be claimed in another claim category, e.g., computer program product, system, storage medium. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

The following applications are incorporated by reference in their entirety for all purposes: (1) U.S. Pat. No. 10,679,729, entitled “Haplotype Phasing Models,” granted on Jun. 9, 2020, (2) U.S. Pat. No. 10,223,498, entitled “Discovering Population Structure from Patterns of Identity-By-Descent,” granted on Mar. 5, 2019, (3) U.S. Pat. No. 10,720,229, entitled “Reducing Error in Predicted Genetic Relationships,” granted on Jul. 21, 2020, (4) U.S. Pat. No. 10,558,930, entitled “Local Genetic Ethnicity Determination System,” granted on Feb. 11, 2020, (5) U.S. Pat. No. 10,114,922, entitled “Identifying Ancestral Relationships Using a Continuous Stream of Input,” granted on Oct. 30, 2018, (6) U.S. Pat. No. 11,429,615, entitled “Linking Individual Datasets to a Database,” granted on Aug. 30, 2022, (7) U.S. Pat. No. 10,692,587, entitled “Global Ancestry Determination System,” granted on Jun. 23, 2020, and (8) U.S. Patent Application Publication No. US 2021/0034647, entitled “Clustering of Matched Segments to Determine Linkage of Dataset in a Database,” published on Feb. 4, 2021.

### Additional Embodiments

Clause 1: A computer-implemented method, comprising: receiving a set of phased genetic data, each corresponding to a plurality of siblings that can be as few as two; identifying, from the phased genetic data, the set of sibling chromosome copies that were inherited by each of the siblings from the same target parent; identifying, from the set of sibling chromosome copies, one or more agreement regions and disagreement regions between at least two sibling chromosome copies; identifying the single or both haplotypes within the agreement and disagreement regions and assimilating them to reconstruct the unphased genome of the target parent; accessing a plurality of relative chromosome datasets, wherein each relative chromosome dataset belongs to a relative who shares genetic data with one or more of the plurality of the siblings; identifying matchings between the plurality of relative chromosome datasets and the one or more agreement regions and disagreement regions by identifying matched segments between the relative chromosome datasets and the one or more agreement regions and disagreement regions; alternatively identifying matched segments between the plurality of relative chromosome datasets and any of the sibling genomes which overlap the transition point between one or more agreement regions and disagreement regions of the siblings and inferring in which sibling the recombination breakpoint occurred; arranging, in a phasing matrix, the identified matchings, wherein the phasing matrix assigns each of the agreement regions and disagreement regions to a relational (not necessarily absolute) grandparent label based on the matchings; reducing, on the phasing matrix, an overall discrepancy in the absolute grandparent label assignments across all chromosomes; and reconstructing a phased genome of the target parent using the one or more agreement regions and disagreement regions based on the grandparent assignment.

Clause 2: A computer-implemented method, further wherein accessing a plurality of relative chromosome datasets comprises: identifying one or more relatives with chromosome datasets having shared identity-by-descent (IBD) segments with the set of sibling chromosome copies; and assessing the one or more relatives for relationship to the target parent through either a single grandparent side or through both grandparent sides.

Clause 3: A computer-implemented method, further wherein arranging, in a phasing matrix, the identified matchings comprises: recording the identified matchings by chromosome or region for each relative.

Clause 4: A computer-implemented method, further wherein arranging, in a phasing matrix, the identified matchings comprises: recording the identified matchings in the phasing matrix including the agreement regions and disagreement regions of two siblings in bi-rows with shared identity-by-descent (IBD) segments.

Clause 5: A computer-implemented method, further wherein identifying one or more agreement regions and disagreement regions between at least two sibling chromosome copies comprises: alternatively assessing the set of sibling chromosome copies from the target parent to identify regions of agreement or disagreement in the set of sibling chromosome copies.

Clause 6: A computer-implemented method, further wherein reducing, on the phasing matrix, an overall discrepancy in grandparent assignment across all chromosomes comprises: performing, on the phasing matrix, an algorithm that achieves a desired objective through single row or column permutations.

Clause 7: A computer-implemented method, further wherein reducing, on the phasing matrix, an overall discrepancy in grandparent assignment across all chromosomes comprises: performing, on the phasing matrix, an algorithm that achieves a desired objective through bi-row or multi-row permutations.

Clause 8: A computer-readable storage medium having stored thereon computer-executable instructions that, when executed by one or more processors, cause the one or more processors to perform operations, comprising: receiving a set of phased genetic data, each corresponding to a plurality of siblings that can be as few as two; identifying, from the phased genetic data, the set of sibling chromosome copies that were inherited by each of the siblings from the same target parent; identifying, from the set of sibling chromosome copies, one or more agreement regions and disagreement regions between at least two sibling chromosome copies; identifying the single or both haplotypes within the agreement and disagreement regions and assimilating them to reconstruct the unphased genome of the target parent; accessing a plurality of relative chromosome datasets, wherein each relative chromosome dataset belongs to a relative who shares genetic data with one or more of the plurality of the siblings; identifying matchings between the plurality of relative chromosome datasets and the one or more agreement regions and disagreement regions by identifying matched segments between the relative chromosome datasets and the one or more agreement regions and disagreement regions; alternatively identifying matched segments between the plurality of relative chromosome datasets and any of the sibling genomes which overlap the transition point between one or more agreement regions and disagreement regions of the siblings and inferring in which sibling the recombination breakpoint occurred; arranging, in a phasing matrix, the identified matchings, wherein the phasing matrix assigns each of the agreement regions and disagreement regions to a relational (not necessarily absolute) grandparent label based on the matchings; reducing, on the phasing matrix, an overall discrepancy in the absolute grandparent label assignments across all chromosomes; and reconstructing a phased genome of the target parent using the one or more agreement regions and disagreement regions based on the grandparent assignment.

Clause 9: A computer-readable storage medium, further wherein accessing a plurality of relative chromosome datasets comprises: identifying one or more relatives with chromosome datasets having shared identity-by-descent (IBD) segments with the set of sibling chromosome copies; and assessing the one or more relatives for relationship to the target parent through either a single grandparent side or through both grandparent sides.

Clause 10: A computer-readable storage medium, further wherein arranging, in a phasing matrix, the identified matchings comprises: recording the identified matchings by chromosome or region for each relative.

Clause 11: A computer-readable storage medium, further wherein arranging, in a phasing matrix, the identified matchings comprises: recording the identified matchings in the phasing matrix for the agreement regions and disagreement regions of two siblings in bi-rows with shared identity-by-descent (IBD) segments.

Clause 12: A computer-readable storage medium, further wherein identifying one or more agreement regions and disagreement regions between at least two sibling chromosome copies comprises: alternatively assessing the set of sibling chromosome copies from the target parent to identify regions of agreement or disagreement in the set of sibling chromosome copies.

Clause 13: A computer-readable storage medium, further wherein reducing, on the phasing matrix, an overall discrepancy in the absolute grandparent label assignments across all chromosomes comprises: performing, on the phasing matrix, an algorithm that achieves a desired discrepancy objective through single row or column permutations.

Clause 14: A computer-readable storage medium, further wherein reducing, on the phasing matrix, an overall discrepancy in the absolute grandparent label assignments across all chromosomes comprises: performing, on the phasing matrix, an algorithm that achieves a desired discrepancy objective through bi-row or multi-row permutations.

Clause 15: A computer system, comprising: one or more processors; and a hardware storage device having stored thereon computer-executable instructions that, when executed by the one or more processors, causes the computer system to perform operations, comprising: receiving a set of phased genetic data, each corresponding to a plurality of siblings that can be as few as two; identifying, from the phased genetic data, the set of sibling chromosome copies that were inherited by each of the siblings from the same target parent; identifying, from the set of sibling chromosome copies, one or more agreement regions and disagreement regions between at least two sibling chromosome copies; identifying the single or both haplotypes within the agreement and disagreement regions and assimilating them to reconstruct the unphased genome of the target parent; accessing a plurality of relative chromosome datasets, wherein each relative chromosome dataset belongs to a relative who shares genetic data with one or more of the plurality of the siblings; identifying matchings between the plurality of relative chromosome datasets and the one or more agreement regions and disagreement regions by identifying matched segments between the relative chromosome datasets and the one or more agreement regions and disagreement regions; alternatively identifying matched segments between the plurality of relative chromosome datasets and any of the sibling genomes which overlap the transition point between one or more agreement regions and disagreement regions of the siblings and inferring in which sibling the recombination breakpoint occurred; arranging, in a phasing matrix, the identified matchings, wherein the phasing matrix assigns each of the agreement regions and disagreement regions to a relational (not necessarily absolute) grandparent label based on the matchings; reducing, on the phasing matrix, an overall discrepancy in the absolute grandparent label assignments across all chromosomes; and reconstructing a phased genome of the target parent using the one or more agreement regions and disagreement regions based on the grandparent assignment.

Clause 16: A computer system, further wherein accessing a plurality of relative chromosome datasets comprises: identifying one or more relatives with chromosome datasets having shared identity-by-descent (IBD) segments with the set of sibling chromosome copies; and assessing the one or more relatives for relationship to the target parent through either a single grandparent side or through both grandparent sides.

Clause 17: A computer system, further wherein arranging, in a phasing matrix, the identified matchings comprises: recording the identified matchings by chromosome or region for each relative.

Clause 18: A computer system, further wherein arranging, in a phasing matrix, the identified matchings comprises: recording the identified matchings in the phasing matrix for the agreement regions and disagreement regions of two siblings in bi-rows with shared identity-by-descent (IBD) segments.

Clause 19: A computer system, further wherein reducing, on the phasing matrix, an overall discrepancy in the absolute grandparent label assignments across all chromosomes comprises: performing, on the phasing matrix, an algorithm that achieves a desired discrepancy objective through single row or column permutations.

Clause 20: A computer system, further wherein reducing, on the phasing matrix, an overall discrepancy in the absolute grandparent label assignments across all chromosomes comprises: performing, on the phasing matrix, an algorithm that achieves a desired discrepancy objective through bi-row or multi-row permutations.

Clause 21: A computer-implemented method, comprising: receiving a set of sibling chromosome copies corresponding to a plurality of siblings, the set of sibling chromosome copies comprising each sibling's identified chromosome copy that is inherited from a target parent; identifying, from the set of sibling chromosome copies, one or more agreement regions and disagreement regions between at least two sibling chromosome copies; accessing a plurality of relative chromosome datasets, wherein each relative chromosome dataset belongs to a relative who shares genetic data with one or more of the plurality of the siblings; identifying matchings between the plurality of relative chromosome datasets and the one or more agreement regions and disagreement regions by identifying matched segments between the relative chromosome datasets and the one or more agreement regions and disagreement regions; arranging, in a phasing matrix, the identified matchings, wherein the phasing matrix assigns each of the agreement regions and disagreement regions to a grandparent based on the matchings; reducing, on the phasing matrix, an overall discrepancy in grandparent assignment across all chromosomes; and reconstructing a phased genome of the target parent using the one or more agreement regions and disagreement regions based on the grandparent assignment.

Clause 22: A computer-implemented method, further wherein accessing a plurality of relative chromosome datasets comprises: identifying one or more relatives with chromosome datasets having shared identity-by-descent (IBD) segments with the set of sibling chromosome copies; and assessing the one or more relatives for relationship to the target parent through either a single grandparent side or through both grandparent sides.

Clause 23: A computer-implemented method, further wherein arranging, in a phasing matrix, the identified matchings comprises: recording the identified matchings by chromosome or region for each relative.

Clause 24: A computer-implemented method, further wherein arranging, in a phasing matrix, the identified matchings comprises: recording the identified matchings by in the phasing matrix including the agreement regions and disagreement regions of two siblings in bi-rows with shared identity-by-descent (IBD) segments.

Clause 25: A computer-implemented method, further wherein identifying one or more agreement regions and disagreement regions between at least two sibling chromosome copies comprises: alternatively assessing the set of sibling chromosome copies from the target parent to identify regions of agreement or disagreement in the set of sibling chromosome copies.

Clause 26: A computer-implemented method, further wherein reducing, on the phasing matrix, an overall discrepancy in grandparent assignment across all chromosomes comprises: performing, on the phasing matrix, an algorithm that through single row or column permutations.

Clause 27: A computer-implemented method, further wherein reducing, on the phasing matrix, an overall discrepancy in grandparent assignment across all chromosomes comprises: performing, on the phasing matrix, an algorithm that through bi-row permutations determines an optimal solution to cross-chromosome phasing of the reconstructed genome.

Clause 28: A computer-readable storage medium having stored thereon computer-executable instructions that, when executed by one or more processors, cause the one or more processors to perform operations, comprising: receiving a set of sibling chromosome copies corresponding to a plurality of siblings, the set of sibling chromosome copies comprising each sibling's identified chromosome copy that is inherited from a target parent; identifying, from the set of sibling chromosome copies, one or more agreement regions and disagreement regions between at least two sibling chromosome copies; accessing a plurality of relative chromosome datasets, wherein each relative chromosome dataset belongs to a relative who shares genetic data with one or more of the plurality of the siblings; identifying matchings between the plurality of relative chromosome datasets and the one or more agreement regions and disagreement regions by identifying matched segments between the relative chromosome datasets and the one or more agreement regions and disagreement regions; arranging, in a phasing matrix, the identified matchings, wherein the phasing matrix assigns each of the agreement regions and disagreement regions to a grandparent based on the matchings; reducing, on the phasing matrix, an overall discrepancy in grandparent assignment across all chromosomes; and reconstructing a phased genome of the target parent using the one or more agreement regions and disagreement regions based on the grandparent assignment.

Clause 29: A computer-readable storage medium, further wherein accessing a plurality of relative chromosome datasets comprises: identifying one or more relatives with chromosome datasets having shared identity-by-descent (IBD) segments with the set of sibling chromosome copies; and assessing the one or more relatives for relationship to the target parent through either a single grandparent side or through both grandparent sides.

Clause 30: A computer-readable storage medium, further wherein arranging, in a phasing matrix, the identified matchings comprises: recording the identified matchings by chromosome or region for each relative.

Clause 31: A computer-readable storage medium, further wherein arranging, in a phasing matrix, the identified matchings comprises: recording the identified matchings by in the phasing matrix including the agreement regions and disagreement regions of two siblings in bi-rows with shared identity-by-descent (IBD) segments.

Clause 32: A computer-readable storage medium, further wherein identifying one or more agreement regions and disagreement regions between at least two sibling chromosome copies comprises: alternatively assessing the set of sibling chromosome copies from the target parent to identify regions of agreement or disagreement in the set of sibling chromosome copies.

Clause 33: A computer-readable storage medium, further wherein reducing, on the phasing matrix, an overall discrepancy in grandparent assignment across all chromosomes comprises: performing, on the phasing matrix, an algorithm that through single row or column permutations.

Clause 34: A computer-readable storage medium, further wherein reducing, on the phasing matrix, an overall discrepancy in grandparent assignment across all chromosomes comprises: performing, on the phasing matrix, an algorithm that through bi-row permutations determines an optimal solution to cross-chromosome phasing of the reconstructed genome.

Clause 35. A computer system, comprising: one or more processors; and a hardware storage device having stored thereon computer-executable instructions that, when executed by the one or more processors, causes the computer system to perform operations, comprising: receiving a set of sibling chromosome copies corresponding to a plurality of siblings, the set of sibling chromosome copies comprising each sibling's identified chromosome copy that is inherited from a target parent; identifying, from the set of sibling chromosome copies, one or more agreement regions and disagreement regions between at least two sibling chromosome copies; accessing a plurality of relative chromosome datasets, wherein each relative chromosome dataset belongs to a relative who shares genetic data with one or more of the plurality of the siblings; identifying matchings between the plurality of relative chromosome datasets and the one or more agreement regions and disagreement regions by identifying matched segments between the relative chromosome datasets and the one or more agreement regions and disagreement regions; arranging, in a phasing matrix, the identified matchings, wherein the phasing matrix assigns each of the agreement regions and disagreement regions to a grandparent based on the matchings; reducing, on the phasing matrix, an overall discrepancy in grandparent assignment across all chromosomes; and reconstructing a phased genome of the target parent using the one or more agreement regions and disagreement regions based on the grandparent assignment.

Clause 36: A computer system, further wherein accessing a plurality of relative chromosome datasets comprises: identifying one or more relatives with chromosome datasets having shared identity-by-descent (IBD) segments with the set of sibling chromosome copies; and assessing the one or more relatives for relationship to the target parent through either a single grandparent side or through both grandparent sides.

Clause 37: A computer system, further wherein arranging, in a phasing matrix, the identified matchings comprises: recording the identified matchings by chromosome or region for each relative.

Clause 38: A computer system, further wherein arranging, in a phasing matrix, the identified matchings comprises: recording the identified matchings by in the phasing matrix including the agreement regions and disagreement regions of two siblings in bi-rows with shared identity-by-descent (IBD) segments.

Clause 39: A computer system, further wherein reducing, on the phasing matrix, an overall discrepancy in grandparent assignment across all chromosomes comprises: performing, on the phasing matrix, an algorithm that through single row or column permutations.

Clause 40: A computer system, further wherein reducing, on the phasing matrix, an overall discrepancy in grandparent assignment across all chromosomes comprises: performing, on the phasing matrix, an algorithm that through bi-row permutations determines an optimal solution to cross-chromosome phasing of the reconstructed genome.

Clause 41: A computer-implemented method for reconstructing precursory data segments, the computer-implemented method comprising: receiving a plurality of data instances from a plurality of cognates, each data instance corresponding to one of the cognates; phasing each data instance to generate a pair of phased data segments for each cognate of the plurality of cognates; comparing the phased data segments of the plurality of cognates to identify, for each cognate, one of the phased data segments that is inherited from a target precursor; extracting, for each cognate, the phased data segment that is inherited from the target precursor to form a set of cognate phased data segments that are inherited from the target precursor; identifying data exchange breakpoints in the set of cognate phased data segments, wherein identifying the data exchange breakpoints comprises identifying data mismatch locations among the cognate phased data segments; recording in an information matrix the correlated IBD sharing of the unphased (or locally phased/phased by chromosome) reconstructed parent genome by chromosome or region with each relative in an information matrix; performing on the information matrix an optimization algorithm that through single-row or column permutations minimizes an overall discrepancy across all chromosomes or regions and included relatives to generate a reconstruction solution; and reconstructing a pair of precursory phased data segments based on the identified data exchange breakpoints based on the reconstruction solution.

Clause 42: Recording in an information matrix the correlated IBD sharing of the unphased (or locally phased/phased by chromosome) reconstructed parent genome by chromosome or region with each relative in an information matrix.

Clause 43: Performing on an information matrix an optimization algorithm that through single row or column permutations will minimize the overall discrepancy across all chromosomes or regions and included relatives.

Clause 44: Reconstructing a genome-wide phased genome of the parent by re-ordering the unphased (or locally phased/phased by chromosome) reconstructed genome according to the solution from the optimization algorithm (or combination of multiple solutions to the optimization algorithm from the solution from different combinations of children genomes) for rearranging chromosome copies or agreement/disagreement regions.

What is claimed is:

1. A computer-implemented method for reconstructing precursory data segments, the computer-implemented method comprising:
receiving a plurality of data instances from a plurality of cognates, each data instance corresponding to one of the cognates;
phasing each data instance to generate a pair of phased data segments for each cognate of the plurality of cognates;
comparing the phased data segments of the plurality of cognates to identify, for each cognate, one of the phased data segments that is inherited from a target precursor;
extracting, for each cognate, the phased data segment that is inherited from the target precursor to form a set of cognate phased data segments that are inherited from the target precursor;
identifying data exchange breakpoints in the set of cognate phased data segments, wherein identifying the data exchange breakpoints comprises identifying data mismatch locations among the cognate phased data segments; and
reconstructing a pair of precursory phased data segments based on the identified data exchange breakpoints.

2. The computer-implemented method of claim 1, wherein the plurality of data instances is associated with a plurality of data storage locations from the plurality of cognates, and phasing each data instance comprises:
generating a pair of phased data segments for each cognate for each of the plurality of data storage locations.

3. The computer-implemented method of claim 2, wherein comparing the phased data segments of the plurality of cognates comprise:
comparing the phased data segments of the plurality of cognates that are associated with a same data storage location; and
identifying, for each cognate and for each data storage location, one of the pair of phased data segments that is inherited from one precursor of the cognates and the other of the pair of phased data segments is inherited from the other precursor of the cognates.

4. The computer-implemented method of claim 1, wherein identifying data exchange breakpoints in the set of cognate phased data segments comprises:
at each data mismatch location, determining a data exchange breakpoint using a voting process, wherein a majority of the cognate phased data segments in the voting process does not have the data exchange breakpoint, and a minority of the cognate phased data segments in the voting process has the data exchange breakpoint where a corresponding phased data segment changes from being associated with one ultra-precursor's phased data segment to another ultra-precursor's phased data segment.

5. The computer-implemented method of claim 1, wherein reconstructing a pair of precursory phased data segments based on the identified data exchange breakpoints comprises:
rearranging the set of cognate phased data segments at the identified data exchange breakpoints.

6. The computer-implemented method of claim 1, wherein reconstructing a pair of precursory phased data segments based on the identified data exchange breakpoints comprises:
identifying one or more portions of the set of cognate phased data segments based on the identified data exchange breakpoints; and
assigning each of the one or more portions of the set of cognate phased data segments to a precursor of the target precursor.

7. The computer-implemented method of claim 6, further comprising:
grouping the one or more portions of the set of cognate phased data segments according to the assigned precursor of the target precursor; and
rearranging the grouped portions of the cognate phased data segments to reconstruct a precursory phased data segment that is inherited from the assigned precursor of the target precursor.

8. The computer-implemented method of claim 1, wherein at least two of the plurality of cognates are full cognates who share same two precursors.

9. A computer-readable storage medium having stored thereon computer-executable instructions that, when executed by one or more processors, cause the one or more processors to perform operations, comprising:
receiving a plurality of data instances from a plurality of cognates, each data instance corresponding to one of the cognates;
phasing each data instance to generate a pair of phased data segments for each cognate of the plurality of cognates;
comparing the phased data segments of the plurality of cognates to identify, for each cognate, one of the phased data segments that is inherited from a target precursor;
extracting, for each cognate, the phased data segment that is inherited from the target precursor to form a set of cognate phased data segments that are inherited from the target precursor;
identifying data exchange breakpoints in the set of cognate phased data segments, wherein identifying the data exchange breakpoints comprises identifying data mismatch locations among the cognate phased data segments; and
reconstructing a pair of precursory phased data segments based on the identified data exchange breakpoints.

10. The computer-readable storage medium of claim 9, wherein the plurality of data instances is associated with a plurality of data storage locations from the plurality of cognates, and phasing each data instance comprises:
generating a pair of phased data segments for each cognate for each of the plurality of data storage locations.

11. The computer-readable storage medium of claim 10, wherein comparing the phased data segments of the plurality of cognates comprise:
comparing the phased data segments of the plurality of cognates that are associated with a same data storage location; and
identifying, for each cognate and for each data storage location, one of the pair of phased data segments that is inherited from one precursor of the cognates and the other of the pair of phased data segments is inherited from the other precursor of the cognates.

12. The computer-readable storage medium of claim 9, wherein identifying data exchange breakpoints in the set of cognate phased data segments comprises:
at each data mismatch location, determining a data exchange breakpoint using a voting process, wherein a majority of the cognate phased data segments in the voting process does not have the data exchange breakpoint, and a minority of the cognate phased data segments in the voting process has the data exchange breakpoint where a corresponding phased data segment changes from being associated with one ultra-precursor's phased data segment to another ultra-precursor's phased data segment.

13. The computer-readable storage medium of claim 9, wherein reconstructing a pair of precursory phased data segments based on the identified data exchange breakpoints comprises:
rearranging the set of cognate phased data segments at the identified data exchange breakpoints.

14. The computer-readable storage medium of claim 9, wherein reconstructing a pair of precursory phased data segments based on the identified data exchange breakpoints comprises:
identifying one or more portions of the set of cognate phased data segments based on the identified data exchange breakpoints; and
assigning each of the one or more portions of the set of cognate phased data segments to a precursor of the target precursor.

15. The computer-readable storage medium of claim 14, wherein the operations further comprise:
grouping the one or more portions of the set of cognate phased data segments according to the assigned precursor of the target precursor; and
rearranging the grouped portions of the cognate phased data segments to reconstruct a precursory phased data segment that is inherited from the assigned precursor of the target precursor.

16. A computer system, comprising:
one or more processors; and
a hardware storage device having stored thereon computer-executable instructions that, when executed by the one or more processors, causes the computer system to perform operations, comprising:
receiving a plurality of data instances from a plurality of cognates, each data instance corresponding to one of the cognates;
phasing each data instance to generate a pair of phased data segments for each cognate of the plurality of cognates;
comparing the phased data segments of the plurality of cognates to identify, for each cognate, one of the phased data segments that is inherited from a target precursor;
extracting, for each cognate, the phased data segment that is inherited from the target precursor to form a set of cognate phased data segments that are inherited from the target precursor;
identifying data exchange breakpoints in the set of cognate phased data segments, wherein identifying the data exchange breakpoints comprises identifying data mismatch locations among the cognate phased data segments; and
reconstructing a pair of precursory phased data segments based on the identified data exchange breakpoints.

17. The computer system of claim 16, wherein the plurality of data instances is associated with a plurality of data storage locations from the plurality of cognates, and phasing each data instance comprises:
generating a pair of phased data segments for each cognate for each of the plurality of data storage locations.

18. The computer system of claim 17, wherein comparing the phased data segments of the plurality of cognates comprise:
comparing the phased data segments of the plurality of cognates that are associated with a same data storage location; and
identifying, for each cognate and for each data storage location, one of the pair of phased data segments that is inherited from one precursor of the cognates and the other of the pair of phased data segments is inherited from the other precursor of the cognates.

19. The computer system of claim 16, wherein identifying data exchange breakpoints in the set of cognate phased data segments comprises:
at each data mismatch location, determining a data exchange breakpoint using a voting process, wherein a majority of the cognate phased data segments in the voting process does not have the data exchange breakpoint, and a minority of the cognate phased data segments in the voting process has the data exchange breakpoint where a corresponding phased data segment changes from being associated with one ultra-precursor's phased data segment to another ultra-precursor's phased data segment; and
rearranging the set of cognate phased data segments at the identified data exchange breakpoints.

20. The computer system of claim 16, wherein reconstructing a pair of precursory phased data segments based on the identified data exchange breakpoints comprises:
identifying one or more portions of the set of cognate phased data segments based on the identified data exchange breakpoints;
assigning each of the one or more portions of the set of cognate phased data segments to a precursor of the target precursor;
grouping the one or more portions of the set of cognate phased data segments
according to the assigned precursor of the target precursor; and
rearranging the grouped portions of the cognate phased data segments to reconstruct a precursory phased data segment that is inherited from the assigned precursor of the target precursor.
